(19) United States
(12) Patent Application Publication
(10) Pub. No.: US 2021/0224335 A1
(43) Pub. Date: Jul. 22, 2021

(54) LEGAL DOCUMENT EXTRACTION FOR LEGAL MATTER PROGRESS MANAGEMENT SYSTEMS AND METHODS

(71) Applicant: Legal Facts, LLC, San Clemente, CA (US)

(72) Inventor: Andrew Christian Puzder, Mesa, AZ (US)

(21) Appl. No.: 16/748,608

(22) Filed: Jan. 21, 2020

(51) Int. Cl. G06F 16/93; G06F 16/901; G06F 16/903; G06K 9/00; G06K 9/62

(52) U.S. Cl. CPC G06F 16/93; G06F 16/901; G06K 9/6256; G06K 9/00469; G06K 9/00463; G06F 16/90344

(57) ABSTRACT

A system and method of employing a computing device to present a graphical user interface (GUI) for a portfolio for a legal matter and to enable a user to input documents from a file to generate events for the portfolio. A file having a plurality of legal documents associated with the portfolio is obtained. The legal documents are extracted from the file using an artificial intelligence model. A name is automatically selected for each respective extracted legal document based on a match between keywords in the document and a list of known legal document names. An event is automatically generated for each document based on the name of the document and data within the document. The portfolio is updated with the plurality of extracted legal documents and the generated events and the plurality of extracted legal documents and the generated events are presented to a user.

### TECHNICAL FIELD

The present disclosure is related generally to providing a graphical user interface, and particularly to extracting legal documents for presentation and sharing of an interactive legal matter with multiple users.

### BACKGROUND

### Description of the Related Art

Legal proceedings can be very complex with many different parts involving many different parties. These parties not only include the legal parties to the legal proceeding, such as a lawsuit, but also their attorneys, experts, support staff, and other interested persons. Each of these parties may have different tasks to perform or to monitor at different times throughout the legal proceeding. Keeping track of which tasks have been performed, as well as scheduling future tasks, can be very difficult and time consuming, especially as the complexity of the proceeding and the number of parties increases. Therefore, it is often not an easy task for a party to look at a legal proceeding and determine what has taken place and what is the next step. Moreover, many tasks are initiated or identified when a particular document associated with the proceeding is received. Many times, however, multiple documents are received at a single time, which can make identifying tasks more difficult. It is with respect to these and other considerations that the embodiments described herein have been made.

### BRIEF SUMMARY

Briefly described, embodiments are directed towards a graphical user interface that extracts a plurality of documents for a legal matter, generates events based on the extracted documents, and enables a user or entity to modify the documents or events, share a portfolio of events, or view a status bar of the legal matter.

A method may be summarized as including obtaining a file for a portfolio for a legal matter, wherein the file includes a plurality of legal documents; extracting the plurality of legal documents from the file using an artificial intelligence model; selecting a name for each respective extracted legal document of the plurality of extracted legal documents based on a match between keywords in the respective extracted legal document and a list of known legal document names; generating an event for each respective extracted legal document based on the name of the respective extracted legal document and data within the respective legal document; updating the portfolio for the legal matter with the plurality of extracted legal documents and the generated events; and presenting the plurality of extracted legal documents and the generated events to a user. The event for each respective extracted legal document may include a date and a title regarding a task or information about a particular phase in the legal matter. Generating the event for each respective extracted legal document may include determining a type and category for the event based on the name of the respective extracted legal document; and determining a date of the event based on the data within the respective legal document.

The method may further include training the artificial intelligence model from a plurality of training legal documents. Training the artificial intelligence model may include receiving a type of each respective training legal document of the plurality of training legal documents; receiving a document position for each respective training legal document where one or more keywords are located in the respective training legal document; and analyzing the plurality of training legal documents, the type of each respective training legal document, and the document position of the one or more keywords located in each respective training legal document using one or more artificial intelligence training mechanisms to train the artificial intelligence model.

Training the artificial intelligence model may include receiving a type of each respective training legal document of the plurality of training legal documents; receiving a document position for each respective training legal document where one or more keywords are located in the respective training legal document; generating a master list that includes the type of each respective training legal document and the document position of the one or more keywords located in each respective training legal document; and analyzing the master list using one or more artificial intelligence training mechanisms to train the artificial intelligence model. Presenting the plurality of extracted legal documents and the generated events to the user may include selecting a legal document from the plurality of extracted legal documents; presenting the name of the selected legal document to the user; presenting the event for the selected legal document to the user; and presenting a preview of one or more pages of the selected legal document to the user.

The method may further include receiving a modification to one or more of the name of the selected legal document, the event for the selected legal document, or one or more pages of the selected legal document; and updating the portfolio for the legal matter based on the received modification. The method may further include selecting the legal matter prior to extraction of the plurality of legal documents from the file and assigning each respective extracted legal document to the selected legal matter. The method may further include selecting the legal matter for one or more of the plurality of extract legal documents after extraction from the file and assigning each of the one or more extracted legal documents to the selected legal matter.

A non-transitory computer-readable storage medium having stored thereon instructions that, when executed by a processor, may cause the processor to perform actions, may be summarized as including obtaining a file associated with a portfolio for a legal case, wherein the file includes a plurality of legal documents; extracting the plurality of legal documents from the file using an artificial intelligence model; selecting a name for each respective extracted legal document of the plurality of extracted legal documents based on a match between keywords in the respective extracted legal document and a list of known legal document names; generating an event for each respective extracted legal document based on the name of the respective extracted legal document and data within the respective legal document; updating the portfolio for the legal case with the plurality of extracted legal documents and the generated events; and presenting the plurality of extracted legal documents and the generated events to a user. The event for each respective extracted legal document may include a date and a title regarding a task or information about a particular phase in the legal case.

Execution of the instructions by the processor to generate the event for each respective extracted legal document, may cause the processor to perform further actions, the further actions including determining a type and category for the event based on the name of the respective extracted legal document; and determining a date of the event based on the data within the respective legal document.

Execution of the instructions by the processor, may cause the processor to perform further actions, the further actions including training the artificial intelligence model from a plurality of training legal documents.

Execution of the instructions by the processor to train the artificial intelligence model, may cause the processor to perform further actions, the further actions including receiving a type of each respective training legal document of the plurality of training legal documents; receiving a document position for each respective training legal document where one or more keywords are located in the respective training legal document; and analyzing the plurality of training legal documents, the type of each respective training legal document, and the document position of the one or more keywords located in each respective training legal document using one or more artificial intelligence training mechanisms to train the artificial intelligence model.

Execution of the instructions by the processor to train the artificial intelligence model, may cause the processor to perform further actions, the further actions including receiving a type of each respective training legal document of the plurality of training legal documents; receiving a document position for each respective training legal document where one or more keywords are located in the respective training legal document; generating a master list that includes the type of each respective training legal document and the document position of the one or more keywords located in each respective training legal document; and analyzing the master list using one or more artificial intelligence training mechanisms to train the artificial intelligence model.

Execution of the instructions by the processor to present the plurality of extracted legal documents and the generated events to the user, may cause the processor to perform further actions, the further actions including selecting a legal document from the plurality of extracted legal documents; presenting the name of the selected legal document to the user; presenting the event for the selected legal document to the user; and presenting a preview of one or more pages of the selected legal document to the user.

Execution of the instructions by the processor, may cause the processor to perform further actions, the further actions including receiving a modification to one or more of the name of the selected legal document, the event for the selected legal document, or one or more pages of the selected legal document; and updating the portfolio for the legal case based on the received modification.

A computing device may be summarized as including a non-transitory memory that stores computer instructions; and a processor that executes the computer instructions to: obtain a file associated with a portfolio for a legal matter, wherein the file includes a plurality of legal documents; extract the plurality of legal documents from the file using an artificial intelligence model; select a name for each respective extracted legal document of the plurality of extracted legal documents based on a match between keywords in the respective extracted legal document and a list of known legal document names; generate an event for each respective extracted legal document based on the name of the respective extracted legal document and data within the respective legal document; update the portfolio for the legal matter with the plurality of extracted legal documents and the generated events; and present the plurality of extracted legal documents and the generated events to a user.

The processor may further execute the computer instructions to: receive a type of each respective training legal document of a plurality of training legal documents;

receive a document position for each respective training legal document where one or more keywords are located in the respective training legal document; and train the artificial intelligence model based on an analysis of the plurality of training legal documents, the type of each respective training legal document, and the document position of the one or more keywords located in each respective training legal document using one or more artificial intelligence training mechanisms.

The processor may further execute the computer instructions to: receive a type of each respective training legal document of a plurality of training legal documents; receive a document position for each respective training legal document where one or more keywords are located in the respective training legal document; generate a master list that includes the type of each respective training legal document and the document position of the one or more keywords located in each respective training legal document; and train the artificial intelligence model based on an analysis of the master list using one or more artificial intelligence training mechanisms.

The processor may present the plurality of extracted legal documents and the generated events to the user by further executing the computer instructions to: select a legal document from the plurality of extracted legal documents; present the name of the selected legal document to the user; present the event for the selected legal document to the user; present a preview of one or more pages of the selected legal document to the user.

receive a modification to one or more of the name of the selected legal document, the event for the selected legal document, or one or more pages of the selected legal document; and update the portfolio for the legal matter based on the received modification.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings.

FIG. 1 is a context diagram of an environment for providing a legal matter status bar in a graphical user interface to users in accordance with embodiments described herein.

FIGS. 2A-2F illustrate use case example screenshots of a graphical user interface in accordance with embodiments described herein.

FIGS. 3A-3F illustrate an enlarged, simplified example of a legal matter status bar in accordance with embodiments described herein.

FIG. 4 illustrates an alternative enlarged, simplified example of a legal matter status bar in accordance with embodiments described herein.

FIG. 5 is a logical flow diagram showing one embodiment of an overview process by a legal-matter-phase-management server for generating and presenting a graphical user interface with a legal matter status bar to users in accordance with embodiments described herein.

FIG. 6 is a logical flow diagram of one embodiment of a process by a legal-matter-phase-management server for performing event actions and modifying the legal matter status bar in the graphical user interface in accordance with embodiments described herein.

FIG. 7 is a logical flow diagram of one embodiment of a process by a legal-matter-phase-management server for presenting events of a phase on the legal matter status bar in the graphical user interface in accordance with embodiments described herein.

FIG. 8 is a logical flow diagram of one embodiment of a process by a legal-case-phase-management server for generating and sharing a portfolio of a legal case with another user or entity in accordance with embodiments described herein.

FIGS. 9A-9B illustrate a logical flow diagram of one embodiment of a process by a legal-case-phase-management server for management editing and read-only authority of portfolios as they are shared between users in accordance with embodiments described herein.

FIGS. 10A-10E illustrate use case example screenshots of a graphical user interface in accordance with embodiments described herein.

FIG. 11 is a logical flow diagram of one embodiment of a process by a legal-case-phase-management server for extracting legal documents for a legal case in accordance with embodiments described herein.

FIG. 12 is a logical flow diagram of one embodiment of a process by a legal-case-phase-management server for employing a master list of documents for training an artificial intelligence model for legal document extraction in accordance with embodiments described herein.

FIG. 13 is a logical flow diagram of one embodiment of a process by a legal-case-phase-management server for generating and modifying extracted documents and events in accordance with embodiments described herein.

FIGS. 14A-14B illustrate use case example screenshots of a graphical user interface showing extracted documents and events in accordance with embodiments described herein.

FIG. 15 is a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including, but not limited to, the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive, and allows for being based on additional features, functions, aspects, or limitations not described, unless the context clearly dictates otherwise. In addition, throughout the specification, the meaning of “a,” “an,” and “the” include singular and plural references.

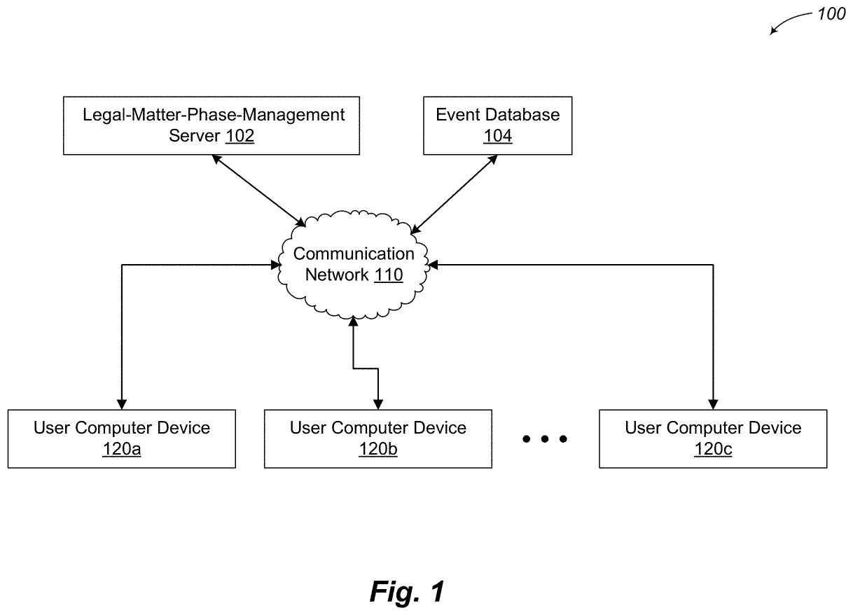

FIG. 1 is a context diagram of an environment 100 for providing a legal matter status bar in a graphical user interface to users in accordance with embodiments described herein. Environment 100 includes a legal-matter-phase-management server 102 in communication with an event database 104 and a plurality of user computer devices 120a-120c (collectively 120) via a communication network 110. Examples of the user computer devices 120a-120c include smart phones, tablet computers, laptop computers, desktop computers, or other computing devices.

The legal-matter-phase-management server 102 is a computer device, such as a server computer or cloud-computing resources, that generates and presents a graphical user interface to a user computer device 120. As described herein, the graphical user interface may include a status bar for a legal matter. This status bar is also referred to herein as a legal matter status bar. The legal matter may be a litigation, case, arbitration proceeding, appeal process, patent drafting or prosecution process, contract negotiation, workers compensation, immigration processing, or other legal proceeding that has multiple phases. As described in more detail below, the status bar includes a representation of each of a plurality of phases of the legal matter. Each phase representation includes one or more characteristics that can be changed depending on the status of that phase. For example, a completed phase may be colored green and a phase that has not started may be colored black.

The graphical user interface also includes a marker on or adjacent to the status bar to indicate a current phase in the legal matter. As described below, the marker is associated with a phase that includes a most recently added event. Events are tasks or information about a particular phase in the legal matter. Examples of events may include, but are not limited to, a reminder of a deposition, an indication that a draft was sent to the client, an entry of a document that was received from outside counsel, etc. Events are the input of what is happening with the legal matter. The legal-matter-phase-management server 102 stores the events in event database 104. In some embodiments, the event database 104 may be a standalone or separate computing device from the legal-matter-phase-management server 102. In other embodiments, the event database 104 is stored in the memory of the legal-matter-phase-management server 102. In various embodiments, the events and status bar for a particular legal matter that are viewable or editable by a particular user may be referred to as a portfolio.

The graphical user interface may also present a portfolio for the legal matter to the user. The portfolio presents a collection of documents and events that represent one or more aspects of the legal matter. The user interface enables a user to view the portfolio and to share it with other users, as described in more detail below.

The graphical user interface may also present an interface in which the user can extract legal documents and corresponding events for the legal matter from one or more files. Details about the extracted legal documents or events can be modified by the user via the graphical user interface, which is described in more detail below.

The legal-matter-phase-management server 102 presents the graphical user interface to users of the user computer devices 120a-120c. The users may be people, groups of people, companies, businesses, firms, or other entities. In some embodiments, the user computer devices 120a-120c access the graphical user interface via an interactive website or web portal hosted or created by the legal-matter-phase-management server 102. In other embodiments, the user computer devices 120a-120c may have stored thereon an application or program that renders the graphical user interface to the users of the user computer devices 120a-120c. In such an embodiment, the legal-matter-phase-management server 102 generates the information (e.g., what phases to represent on the status bar, where to position the marker, etc.) to render the graphical user interface. In yet other embodiments, the functionality of the legal-matter-phase-management server 102 is provided by the user computer devices 120 themselves, such as via an application or program installed on the user computer devices 120.

The user computer devices 120 also receive user interactions with the graphical user interface and provide them to the legal-matter-phase-management server 102 via communication network 110. The user interactions may include, but are not limited to, entry of new events, selection of a phase representation on the status bar, updates to events, upload of files for document extraction, extracted document review or modification, etc.

The communication network 110 may be configured to couple various computing devices to transmit content/data from one or more computing devices to one or more other computing devices. For example, communication network 110 may be the Internet, X.25 networks, or a series of smaller or private connected networks that carry the content and other data. Communication network 110 may include one or more wired or wireless networks.

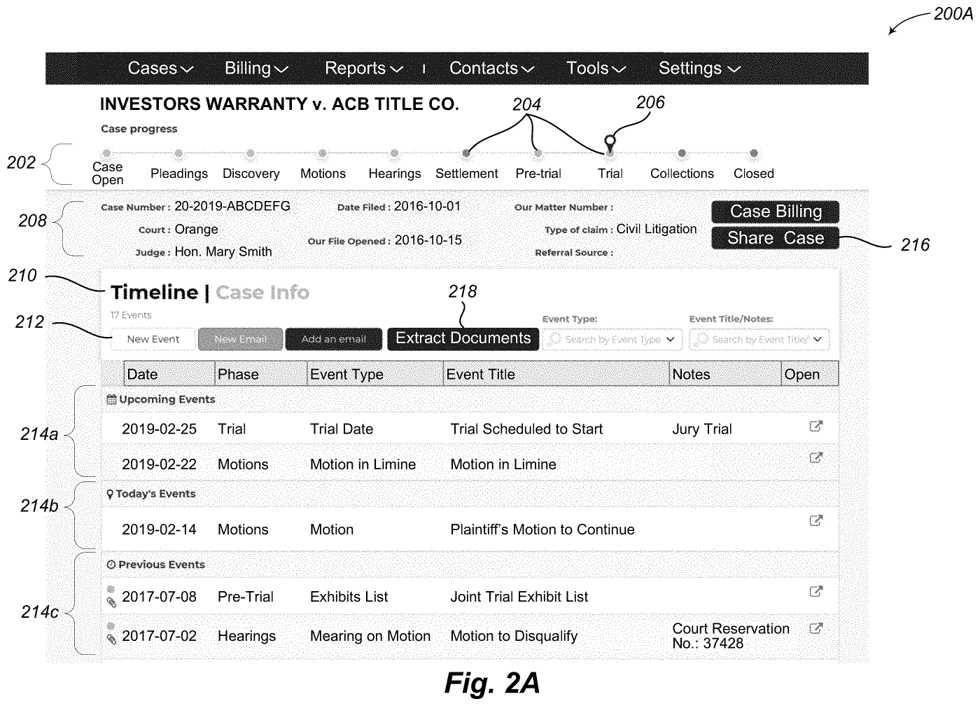

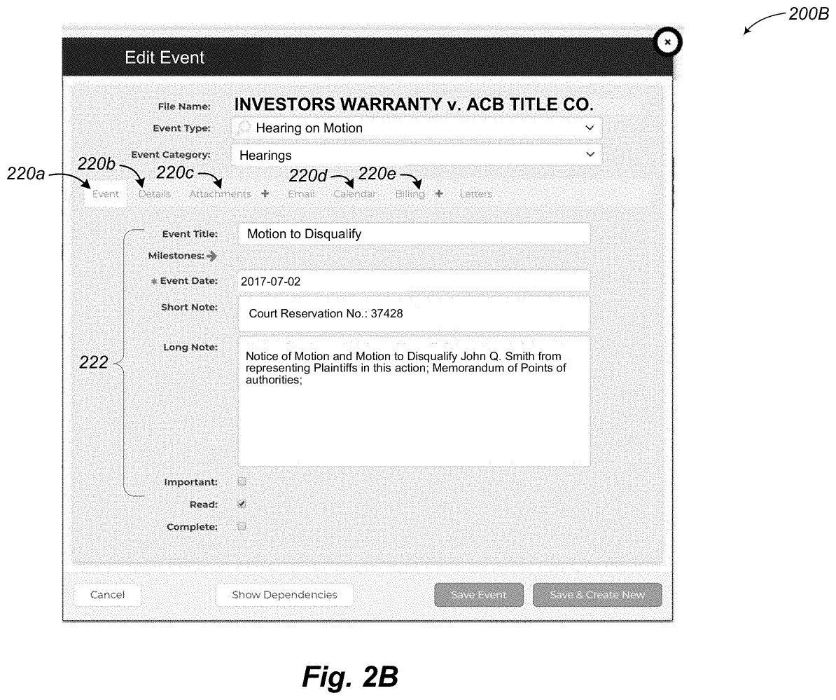

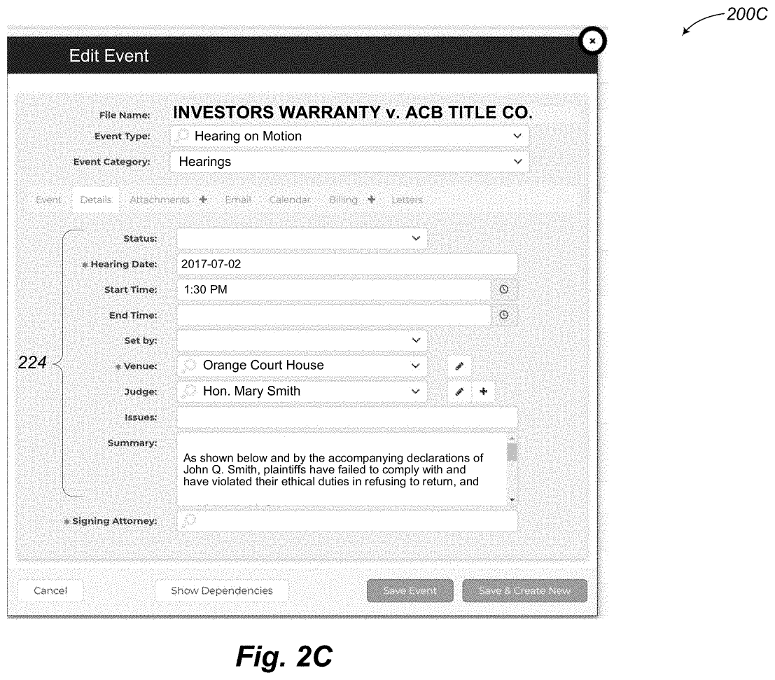

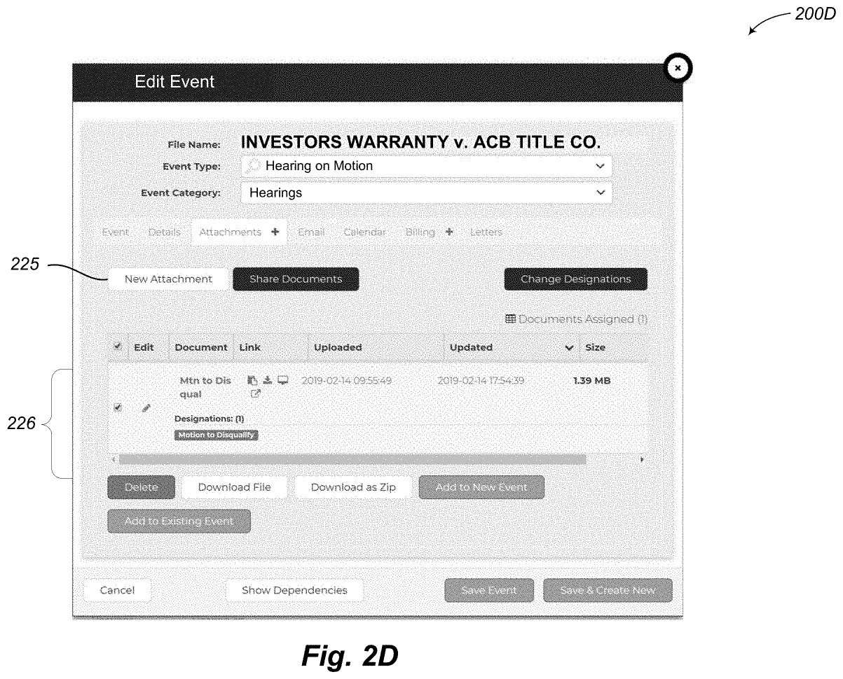

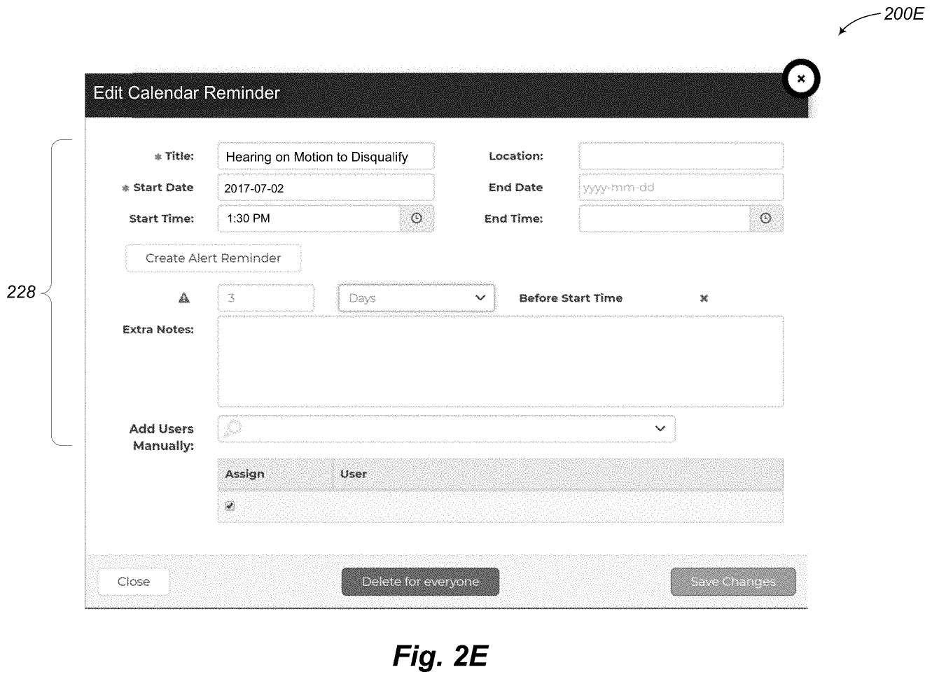

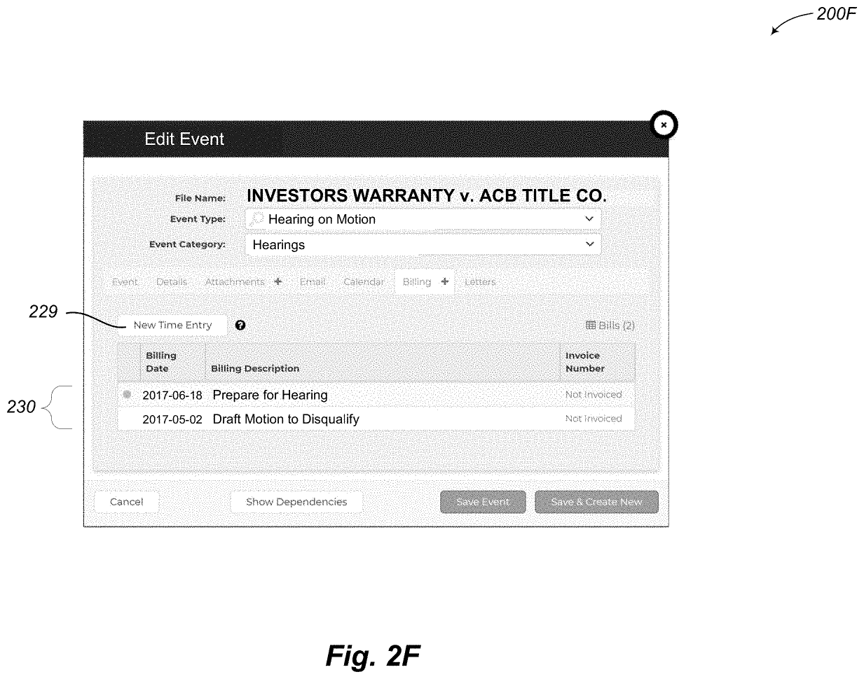

FIGS. 2A-2F illustrate use case example screenshots of a graphical user interface in accordance with embodiments described herein. Interfaces 200A-200F in FIGS. 2A-2F, respectively, may be a collection of graphical user interfaces that are generated and presented to a user, and may be collectively referred to as a graphical user interface.

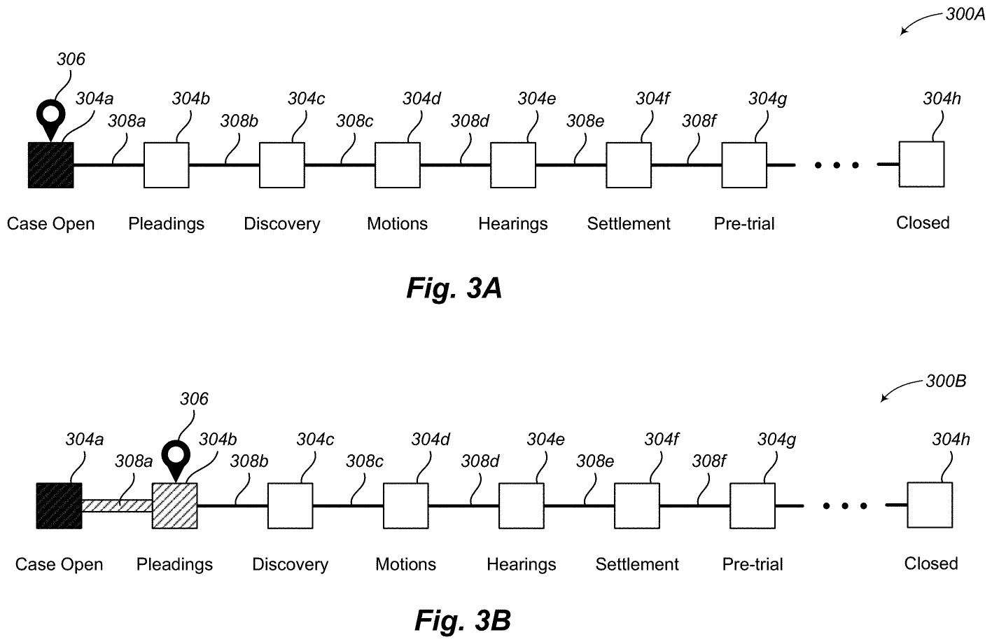

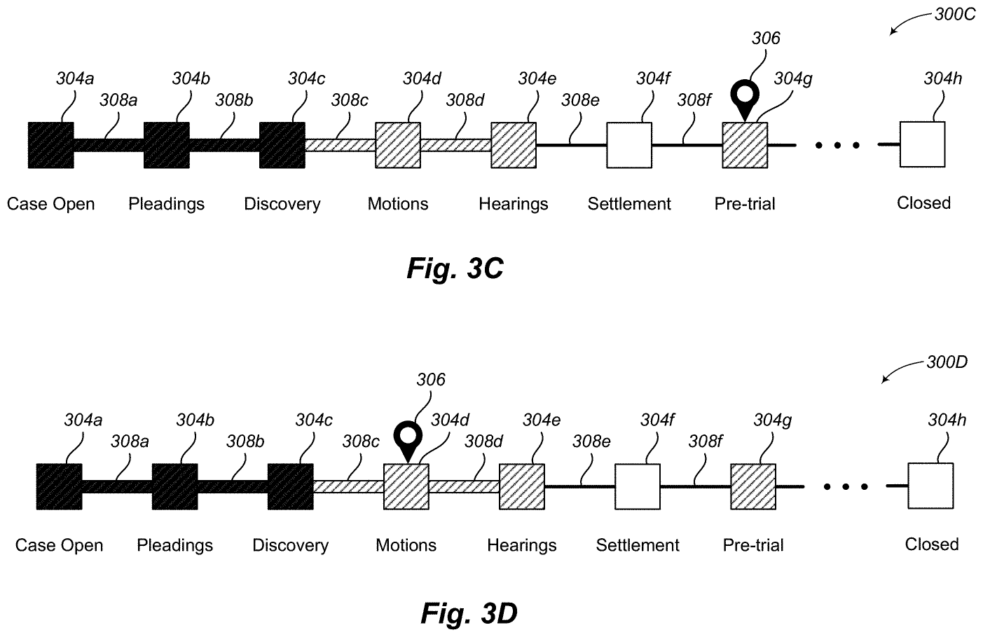

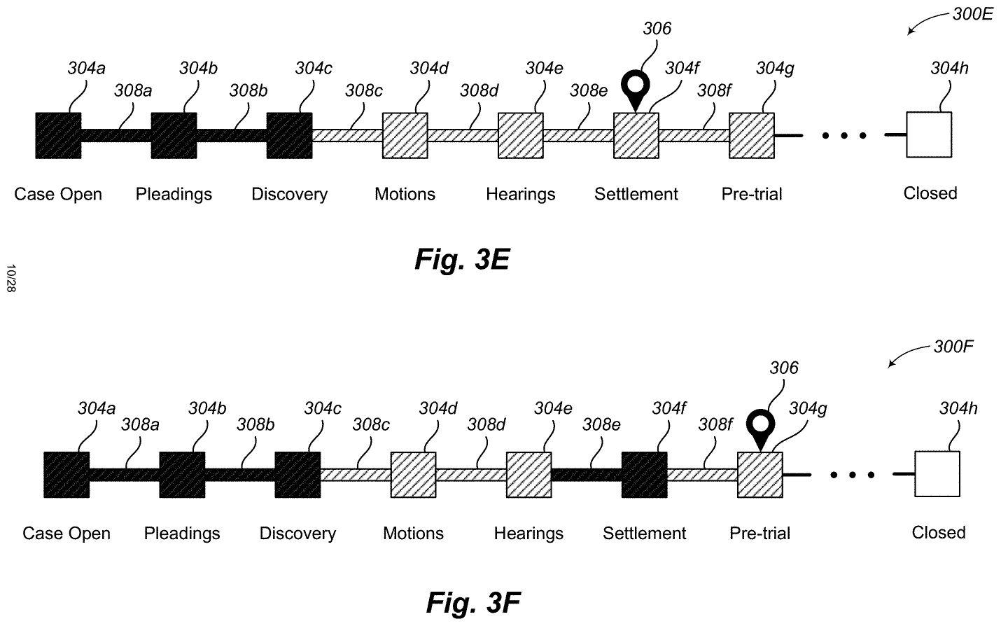

Interface 200A in FIG. 2A is a graphic user interface of a legal matter status bar 202 with which the user can interact. An enlarged, simplified example of the status bar 202 is illustrated in FIGS. 3A-3F. Briefly, however, the status bar 202 includes a plurality of phase representations 204. Each phase representation 204 is associated with a phase of the legal matter. In this illustrated example, the phases include: matter open, pleadings, discovery, motions, hearings, settlement, pre-trial, trial, collections, and closed. Other numbers and types phases may also be employed. In various embodiments, the phases represented on the status bar 202 are set by a developer or administrator and cannot be changed by a user. In other embodiments, the user may define, or select from pre-defined phases, the phases are to be represented on the status bar 202. In yet other embodiments, the user may be enabled to split a pre-defined phase into multiple representations or combine multiple representations into a single representation. For example, the user may combine a pre-trial phase representation with a trial phase representation.

A marker 206 is included in the status bar 202 and is associated with a current phase of the phase representations 204. In various embodiments, the current phase may be the phase with a most recently added event. The marker 206 moves from one phase representation 204 to another as the legal matter progresses based on the addition and status of the events.

The interface 200A also includes matter information 208. The matter information 208 may include, but is not limited to: matter number, date filed or started, client or attorney matter number, court or jurisdiction for the matter, judge or reviewer or overseer, type of matter, etc. Moreover, the interface 200A includes a button 216, which allows the user to share this particular case or portfolio with another user, which is described in more detail below.

The interface 200A is also displaying a timeline 210. The timeline 210 lists a plurality of events 214a-214c (collectively 214) already entered by the user. The events 214 may be listed in chronological order. In some embodiments, the events 214 may be grouped into upcoming events 214a, today's events 214b, and previous events 214c, as illustrated. Each event 214 includes a due date, phase, event type, and event title. The events 214 may also include milestones, notes, attachments, or other information.

A user can create a new event 214 by clicking on the new event button 212, which may navigate to another screen or open another window, such as interface 200B in FIG. 2B. In other embodiments, the user can create a new event 214 by clicking on a particular phase representation 204. By clicking on a particular phase representation 204, the system may navigate to another screen or open another window, such as interface 200B in FIG. 2B, where at least some of the information is pre-selected based on the particular phase representation 204. For example, if the user clicks on the phase representation 204 for “Hearings” then “Hearings” may be preselected, preassigned, or prepopulated as the phase name or phase category for the new event.

Interface 200B in FIG. 2B is a graphic user interface in which a user can add or modify information associated with an event. The interface 200B includes multiple input boxes 222, where the user can enter information about the event. In various embodiments, the information requested in input boxes 222 may be subjective or tailored for the particular event being added or modified, which may be identified based on the phase associated with the event. Examples of the information that may be included in the input boxes 222 may include, but are not limited to, an event type, event phase, event title, event date, notes, etc. The event type identifies the nature of the event. The event phase identifies the phase in the legal matter with which the event is associated. In some embodiments, the event phase may also be referred to as the event category. The event date is the date in which a task is to occur or be completed, or the date on which the task has occurred or was completed. For example, if the event is a hearing, then the event date is the date of the hearing. Alternatively, if the event is draft opinion, then the event date is the target or due date of the opinion. The notes may include short or long notes that can be customized by and meaningful to the user.

The interface 200B also includes multiple input buttons 220a-220e (collectively 220). When a user clicks on an input button 220, additional screens or windows open to allow the user to enter additional information for the event. For example, input button 220a enables the user to enter the data in the input boxes 222; input button 220b opens interface 200C in FIG. 2C for the user to enter additional event details; input button 220c opens interface 200D in FIG. 2D for the user to add documents or attachments to the event; input button 220d opens interface 200E in FIG. 2E for the user to enter calendar reminder information for the event; and input button 220e opens interface 200F in FIG. 2F for the user to enter billing or time entry information for the event. The interface 200B may also include an extract documents button 218, which opens another user interface (not shown) that enables a user to automatically extract documents and generate events from a file containing multiple documents.

Interface 200C in FIG. 2C enables the user to enter additional event details via input boxes 224. In this illustrated example, input boxes 224 enable the user to enter a status of the event (e.g., in progress, complete, drafting, in review, etc.), a date for the event, start and end time for the event, which user set the event, where the event is to be conducted, a judge or reviewer or overseer of the event, issues to present at the event, a summary of the event or arguments to be made, etc.

In some embodiments, the input boxes 224 may be customized for the particular event type or event phase. For example, if the event phase is hearings, then the input boxes 224 may require the user to enter a hearing date. But if the event phase is settlement, then the input boxes 224 may include a text box for the user to enter a settlement offer amount. Moreover, some of the details provided in the input boxes 224 may have been pre-populated based on details provided in interfaces 220B in FIG. 2B or 200E in FIG. 2E.

Interface 200D in FIG. 2D enables the user to add documents or attachments to the event. For example, the user can click button 225, which may open a window that enables the user to select one or more files or documents to attach to the event. A brief summary 226 of the attached documents is also provided to the user.

Interface 200E in FIG. 2E enables the user to enter calendar reminder information via input boxes 228. For example, the user can enter the title of the event, a start and end time for the event, a location of the event, a date of the event, a calendar reminder, additional notes, select which users or people are to participate, etc. Some of the details provided in the input boxes 228 may have been pre-populated based on details provided in interfaces 220B in FIG. 2B or 200C in FIG. 2C.

Interface 200F in FIG. 2F enables the user to enter billing or time entry information for the event. For example, the user can click button 229, which may open a window that enables the user to input a date, description, and time accrued for work done. A summary 230 of the billed time may be provided to the user.

The example interfaces shown in FIGS. 2A-2F are for illustrative purposes and may be different in look and the amount of information requested from or shown to the user.

FIGS. 3A-3F illustrate an enlarged, simplified example of a legal matter status bar in accordance with embodiments described herein.

Status bar 300A in FIG. 3A illustrates an initial status bar after a legal matter is opened. The status bar 300A includes a representation 304a-304h (collectively 304) for each phase in the legal matter. In some embodiments, one or more characteristics of the phase representations 304 may be modified depending on the status of one or more events associated with the phase. In this illustration, the representations 304 that are unfilled (representations 304b-304h) indicate that those corresponding phases have not yet started. A phase has not started when there are no events associated with that phase. Conversely, representations that are filled with solid black (representation 304a) indicate that a phase is complete. In some embodiments, a phase is complete when one event associated with that event is identified as being complete, such as by user input. In other embodiments, a phase is complete when each and every event associated with that phase is identified as being complete.

The status bar 300A also includes a marker 306. The marker 306 is associated with the phase of a most recently added event. In this example, the only phase with an event is the phase associated with the representation 304a. Therefore, marker 306 is associated with phase representation 304a. In this illustrated example, the marker 306 is a pin-like symbol that is abuts or connects to the applicable phase representation 304. Other symbols and placements of the marker 306 may be utilized. For example, the marker 306 may be a circle around the phase representation 304 or some other color or characteristic of the phase representation 304.

Status bar 300B in FIG. 3B illustrates an example where one or more events have been added to the pleadings phase, which is shown by the hatching of phase representation 304b. Because an event has been added to phase representation 304b, the marker 306 is moved to phase representation 304b.

As the legal matter progresses, additional events may be added to the other phase representations 304 and some may even be completed. An example of such progress is illustrated by Status bar 300C in FIG. 3C. In this illustrated example, the pleadings and discovery phases shown by representations 304b and 304c, respectively have been completed (illustrated by solid black fill), and the motions, hearings, and pre-trial phases shown by representations 304d, 304e, and 304g, respectively, have been started (illustrated by the hatched fill). Moreover, the most recently added event among all phases 304 was added to the pre-trial phase. Therefore, the marker 306 was moved to the pre-trial phase shown by representation 304g. The settlement and closed phases shown by representations 304f and 304h, respectively, have not yet started (illustrated as unfilled).

Because the marker 306 moves to the phase representation of the phase with the most recently added event, the marker 306 can be moved to any phase with at least one event. The representations of these events may be identified as being eligible to receive the marker. Status bar 300D in FIG. 3D illustrates an example, where the latest event was added to the motions phase shown by representation 304d. In this example, however, the pre-trial phase shown by representation 304g has not been completed, so it remains as started but not complete (illustrated by hatched fill).

If an event is added to the settlement phase, then its phase representation 304f is changed from unfilled to hatched and the marker 306 is moved to the phase representation 304f, which is shown in by status bar 300E in FIG. 3E.

If the settlement event is completed (e.g., the settlement negotiations failed and were closed), then the phase representation 304f is changed from hatched to solid fill, which is shown by status bar 300F in FIG. 3F. In some embodiments, the marker 306 is moved to or stays on the phase representation 304 of the phase identified as complete. In other embodiments, the marker 306 is moved to a next chronological phase (e.g., the phase that includes event having a next event date), to the next most recently added event, or to a phase selected by the user.

Although FIGS. 3A-3F illustrate a new position of the marker 306 based on events being completed or added to a phase, embodiments are not so limited. For example, in some embodiments not illustrated, arrows may be utilized to indicate the movement of the marker 306. For example, between FIGS. 3E and 3F the marker 306 is moved from the settlement representation 304f to the pre-trial representation 304g. In some embodiments, an arrow may be overlaid or positioned on the status bar 300F to illustrate this movement of the marker 306. In various embodiments, a plurality of arrows may be utilized to show a preselected number of previous movements of the marker 306. In this way, a user can see additional details regarding the progress of the legal matter without having to look at a calendar, timeline, or list of events.

The example status bars shown in FIGS. 3A-3F are for illustrative purposes. In other embodiments, other phases than what are shown may be utilized. Moreover, other shapes of phase representations may be used, other colors or characteristics (size, shape, color, texture, fonts of labels associated with the phase representations, etc.) may be modified based on whether the phase is not started, started, or complete. Likewise, additional status bar features may be utilized to illustrate the progress of the legal matter.

For example, in some embodiments, the status bars 300A-300F may include connections 308a-308f (collectively 308) between adjacent phase representations 304a-304g. One or more characteristics (e.g., color, texture, shape, size, fonts of labels, etc.) of one or more connections may be changed based on updates to one or more phases. In various embodiments, the connection that is prior to (e.g., to the left of) a phase representation may be modified when the status of that phase has changed. In one embodiment, the connection that is after (e.g., to the right of) a phase representation may not be modified when the status of that phase has changed. In some embodiments, a connection prior to a phase representation may change so long as the immediately preceding phase has started or been completed, but the connection may not change if the immediately preceding phase has not started or been completed.

For example, in FIG. 3A, the connections 308a-308f are solid skinny lines because the phases associated with the phase representations 304b-304g have not started. But in FIG. 3B, the pleadings phase shown by representation 304b has started (illustrated by the hatched fill). In this illustrated example, the connection 308a between the case open phase representation 304a and the pleadings phase representation 304b has changed to be a hatched thick line to show progress from the case open phase to the pleadings phase.

As the legal matter progresses and additional phases are completed and started, the connections 308 along with the representations 304 may be updated, which is illustrated in FIG. 3C. In this illustrated example, the connection 308a between the case open phase representation 304a and the pleadings phase representation 304b has changed to be a solid filled thick line to show that the legal matter has completed the case open phase and the pleadings phase. Likewise, the connection 308b between the pleadings phase representation 304b and the discovery phase representation 304c has changed to be a solid filled thick line to show that the legal matter has also completed the discovery phase. Moreover, the connection 308c between the discovery phase representation 304c and the motions phase representation 304d and the connection 308d between the motions phase representation 304d and the hearings phase representation 304e have changed to be hatched thick lines to show that the motions and hearings phases have started, but are not yet complete. In this example, the pre-trial phase shown by representation 304g has also started. However, because the immediately preceding phase (settlement) has not started (illustrated by phase representation 304f being unfilled), connection 308f has not changed and is still a solid skinny line.

If an event is added to an already started phase, which results in moving the marker 306, the connection associated with that phase representation may not be modified—unless the phase status itself changes (e.g., changes to complete). An example of this scenario is shown in FIG. 3D with connections 308a and 308b staying as solid thick lines, connections 308c and 308d staying as hatched thick lines, and connections 308e and 308f staying as solid thin lines.

If a new phase is started and phases before and after the new phases have previously started, the connection between the new phase and the immediately preceding phase is modified and the connection between the new phase and the immediately following phase is also modified. An example of this scenario is shown in FIG. 3E. For example, in FIG. 3D the settlement phase has not yet started (illustrated by the representation 304f being unfilled) and its corresponding connections 308e and 308f are solid thin lines, even though the hearings and pre-trial phases have started (which are illustrated by representations 304e and 304g being hatch filled). But when the settlement phase is started and its phase representation 304f is changed to be hatch filled, the connections 208e and 308f are changed to be hatched thick lines, which is illustrated in FIG. 3E.

If the settlement phase becomes complete, with no other changes to the other phases, then the connection 308e preceding the settlement representation 304f is modified to be a solid thick line, while the connection 308f following the settlement representation 304f remains as a hatched thick line, which is shown in FIG. 3F.

Although FIGS. 3A-3F illustrate the connections as solid thin lines, hatched thick lines, or solid thick lines, embodiments are not so limited. For example, in some other embodiments not illustrated, colors or other characteristics of the connections may be modified to signal a change of status from one phase to another.

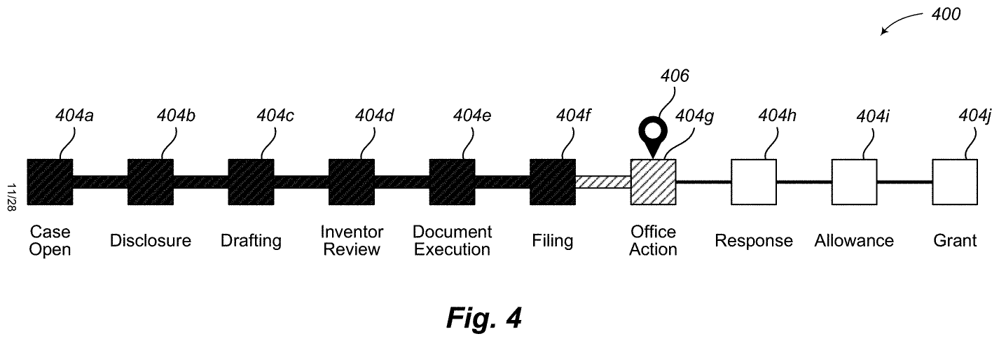

FIG. 4 illustrates an alternative enlarged, simplified example of a legal matter status bar 400 in accordance with embodiments described herein. The status bars 300A-300F in FIGS. 3A-3F illustrate the phases of a typical litigation proceeding as the legal matter. Another example of a legal matter may be a patent application preparation and prosecution. In this example, the status bar 400 includes phase representations 404a-404j for the phases: matter open, disclosure, drafting, inventor review, document execution, filing, office action, response, allowance, grant. Although illustrated as a single status bar, the patent application process may be separated into two or more status bars. For example, one status bar may be for the preparation of the application (e.g., with phases disclosure, drafting, inventor review, document execution, and filing) and another status bar for the prosecution of the application (e.g., with phases filed, office action, response, appeal, allowance, grant).

In this illustrated example, the application has been drafted and filed (illustrated by the matter open, disclosure, drafting, inventor review, document execution, and filing phases 404a-404f being identified as complete using solid black fill) and an office action has been received from the patent office (illustrated by the office action phase 404g including an event shown by the hatched fill). Because an event (receipt of an office action) has been added to the office action phase 404g, the marker 406 is moved to phase 404g.

Other types of proceedings and legal matters may utilize the status bar and its functionality described herein, but with different phases, different numbers of phases, different phase representations, or different phase representation characteristic changes.

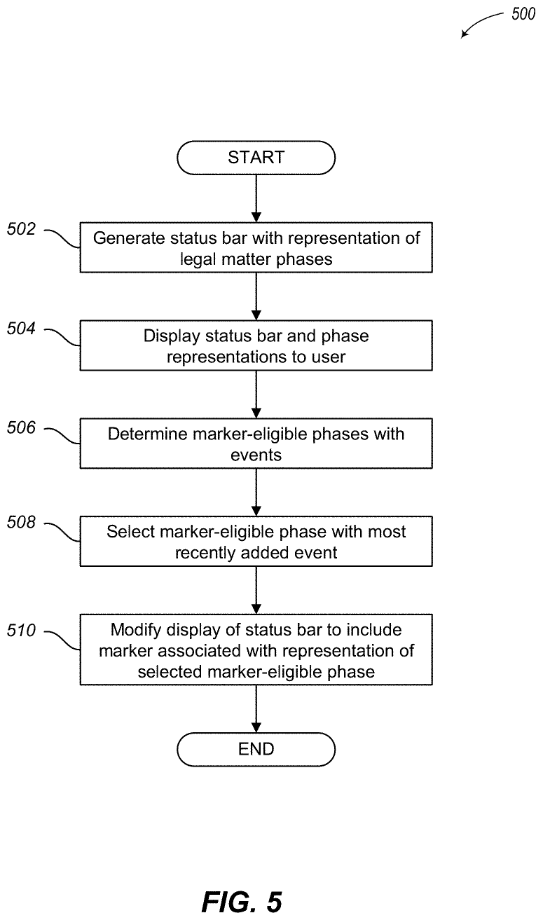

The operation of certain aspects will now be described with respect to FIGS. 5-8 and 9A-9B. Processes 500, 600, 700, 800, and 900 described in conjunction with FIGS. 5, 6, 7, 8, and 9A-9B, respectively, may be implemented by or executed on one or more computing devices, such as the legal-matter-phase-management server 102 in FIG. 1.

FIG. 5 is a logical flow diagram showing one embodiment of an overview process 500 by a legal-matter-phase-management server for generating and presenting a graphical user interface with a legal matter status bar to users in accordance with embodiments described herein.

Process 500 begins, after a start block, at block 502, where a status bar is generated with representations of a plurality of legal matter phases. The plurality of phases represent a chronological order of event groupings throughout the legal matter. One example of the phases may include at least three of: pleadings, discovery, motions, hearings, settlement, pre-trial, trial, and collections. Another example of the phases may include at least three of: disclosure, drafting, inventor review, document execution, filing, office action, response, allowance, and grant.

The status bar may be a horizontal line bar, such as illustrated in FIG. 2A or FIGS. 3A-3F. In other embodiments, the status bar may be a vertical line bar. The representation of each phase on the status bar may include a plurality of characteristics, such as color, shape, size, fonts of representation labels, etc. As described herein, one or more characteristics may change based on the particular status of that corresponding phase.

Process 500 proceeds to block 504, where the status bar and the phase representations are displayed to a user. In various embodiments, the status bar and the phase representations are displayed in a graphical user interface that enables the user to interact with the phase representations.

Process 500 continues at block 506, where marker-eligible phases are determined. In various embodiments, the phases that are marker eligible are those phases that have at least one event. In at least one embodiment, a phase is marker eligible if there is at least one non-complete event associated with the phase. In such an embodiment, if a phase only includes completed events, then it is not eligible for the marker.

Process 500 proceeds next to block 508, where a marker-eligible phase with a most recently added event is selected. The most recently added event may be an event that has the newest timestamp for when it was created by the user. In some other embodiments, the marker-eligible phase that is selected is the phase that includes an event with the next chronological event date. Therefore, if a first phase has an event due tomorrow and a second phase has an event due in two weeks, then the first phase may be selected.

Process 500 continues next at block 510, where the display of the status bar is modified to include a marker associated with the presentation of the selected marker-eligible phase. In some embodiments, the marker is attached to the phase representations, such as illustrated in FIGS. 2A and 3A-3F. In other embodiments, the marker may surround the phase representation or the marker may be a modified characteristic of the representation (e.g., enlarging the phase representation).

After block 510, process 500 terminates or otherwise returns to a calling process to perform other actions.

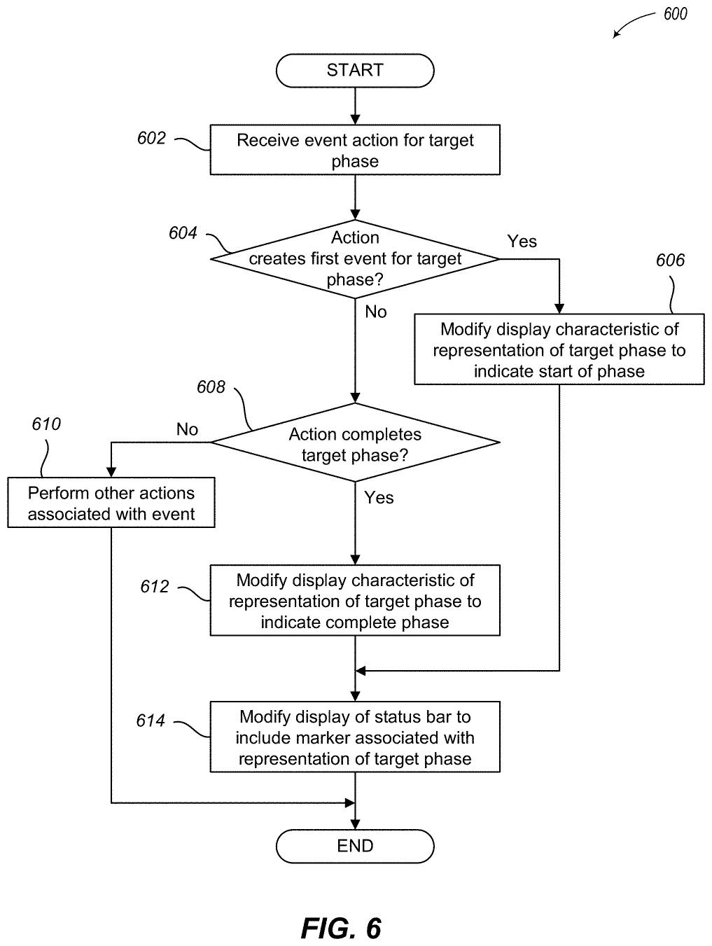

FIG. 6 is a logical flow diagram of one embodiment of a process 600 by a legal-matter-phase-management server for performing event actions and modifying the legal matter status bar in the graphical user interface in accordance with embodiments described herein. Process 600 begins, after a start block, at block 602, where an event action for a target phase is received. In various embodiments, the event action may be to add an event, change a detail or information about an existing event, mark an event as complete, etc.

Process 600 proceeds to decision block 604, where a determination is made whether the action is to create the first event for a target phase. If the event is the first event for a target phase, then process 600 flows to block 606; otherwise process 600 flows to decision block 608.

At block 606, one or more display characteristics of the representation for the target phase is modified to indicate that the target phase has started. In some embodiments, the color, size, or shape of the phase representation is modified. For example, the phase representation may be changed from black or white to yellow. In other embodiments, a font size, color, emphasis, or style of a label associated with the phase representation may be modified. For example, the label “Settlement” associated with the settlement phase representation may be italicized when the settlement phase beings. These examples of modifications to the display characteristics of the representation for the target phase are not limiting and other characteristics or modifications may be performed.

In some embodiments, one or more display characteristics of a connector associated with the representation of target phase may also be modified to indicate progress to the now started target phase. For example, the color of a connector between the representation of the target phase and the representation of a phase immediately preceding the representation of the target phase may be modified from black to yellow. If the phase immediately following the target phase has already been started, then the connector between the representation of the target phase and the representation of the immediately following phase may be modified from black to yellow. These examples of modifications to the display characteristics of the connectors associated with the target phase are not limiting and other characteristics or modifications may be performed.

After block 606, process 600 continues at block 614.

If, at decision block 604, the action does not create a first event for the target phase, process 600 flows from decision block 604 to decision block 608. At decision block 608, a determination is made whether the action completes the target phase. The user may change an event from active or pending to complete. In some embodiments, if the event is labeled as complete, then the phase is labeled as complete. In other embodiments, the phase is labeled as complete only when all events for that phase are labeled as complete. If the action completes the target phase, process 600 flows to block 612; otherwise, process 600 flows to block 610 to perform other actions associated with the event (e.g., change information of the event, update a note or date associated with the event, add an attachment, add a calendar notification, etc.).

At block 612, one or more display characteristics of the representation for the target phase is modified to indicate that the target phase is complete, which may be similar to what is described above in conjunction with block 606 but for a completed phase. In some embodiments, the color, size, or shape of the phase representation is modified. For example, the phase representation may be changed from yellow to green.

In some embodiments, one or more display characteristics of a connector associated with the representation of target phase may also be modified to indicate progress to the now completed target phase. For example, the color of a connector between the representation of the target phase and the representation of a phase immediately preceding the representation of the target phase may be modified from yellow to green. After block 612, process 600 continues at block 614.

At block 614, the display of the status bar is modified to move the marker to be associated with the representation of the target phase. In various embodiments, block 614 may employ embodiments of block 510 in FIG. 5 to modify the display of the status bar to include the marker.

After block 614 or block 610, process 500 terminates or otherwise returns to a calling process to perform other actions.

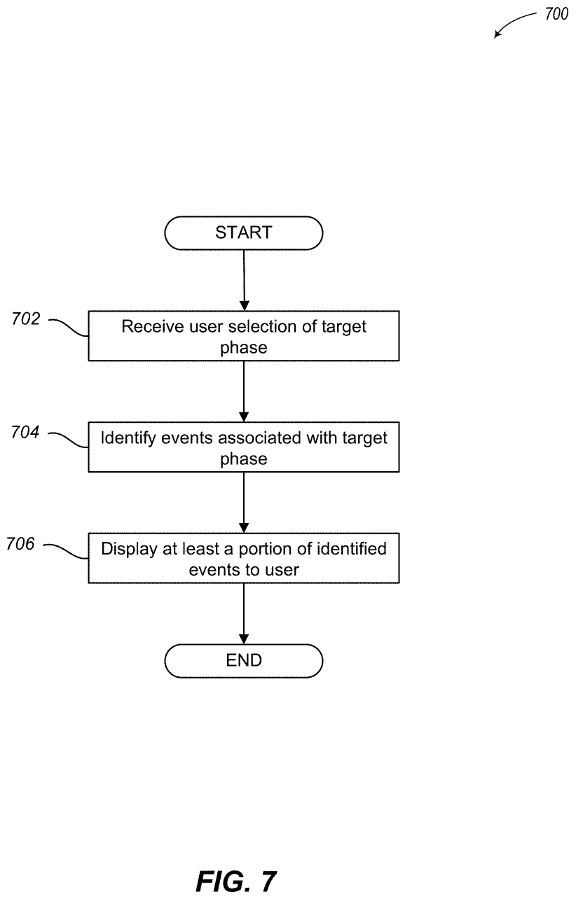

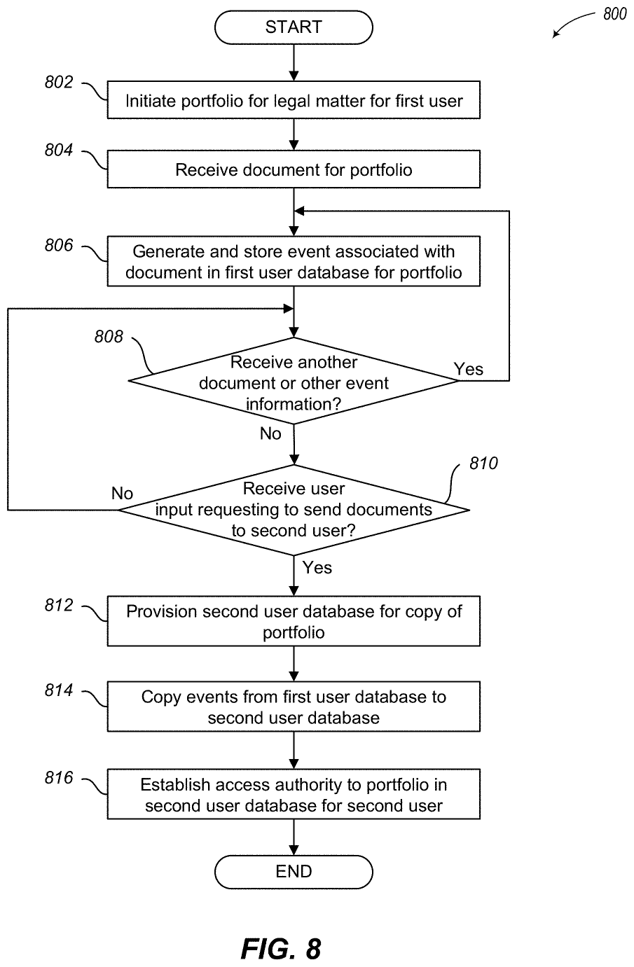

FIG. 7 is a logical flow diagram of one embodiment of a process 700 by a legal-matter-phase-management server for presenting events of a phase on the legal matter status bar in the graphical user interface in accordance with embodiments described herein. Process 700 begins, after a start block, at block 702, where a user selection of a target phase is received via the graphical user interface. In some embodiments, the user may select the target phase by clicking on the corresponding phase representation on the status bar or a label associated with the corresponding phase representation.

Process 700 proceeds to block 704, where the events associated with the target phase are identified. In various embodiments, an events database is searched for those events that are associated with the target phase.

Process 700 continues at block 706, where at least a portion of the identified events are displayed to the user. In some embodiments, a list of the identified events is presented to the user in the graphical user interface. The presentation of the identified events may be in chronological order based on the event start date, the date the event was created, or the event completion date. The order of the events may be selected by the user or predetermined by an administrator or developer.

Presentation of the identified events to the user in chronological order can enable the user to view the events associated with a particular phase (i.e., the target phase associated with the phase representation clicked on by the user) as those events have occurred or are scheduled to occur.

After block 706, process 700 terminates or otherwise returns to a calling process to perform other actions.

FIG. 8 is a logical flow diagram of one embodiment of a process 800 by a legal-case-phase-management server for generating and sharing a portfolio of a legal matter with another user or entity in accordance with embodiments described herein.

Process 800 begins, after a start block, at block 802, where the legal-case-phase-management server initiates a portfolio for a legal matter for a first user. A portfolio for a legal matter may be referred to as an electronic collection of documents and events that represent one or more aspects of the legal matter. In various embodiments, a status bar of event phases, as described herein is included with the portfolio.

In various embodiments, initiating the portfolio for the first user includes establishing a first user database and permissions for the first user to access and modify the portfolio via the first user database. The initiation process may also include presenting a graphical user interface to the first user for the first user to input various information regarding the portfolio, such as the type (e.g., contract dispute, workers compensation lawsuit, patent application filing, will preparation, etc.), party names, applicable court or jurisdiction, etc.

Process 800 proceeds to block 804, where the legal-case-phase-management server receives a document for the portfolio. In various embodiments, a graphical user interface is presented to the first user for the user to upload a document for the portfolio, such as illustrated in FIG. 2C. The document may be a draft document to provide to a client or to counsel, a court order, evidence or exhibit, or other types of documents related to the portfolio or legal matter. In other embodiments, a graphical user interface is presented to the first user for the user to upload a file that includes a plurality of documents for the portfolio. As described in more detail below, the plurality of documents are extracted from the file using a trained artificial intelligence model.

Process 800 continues at block 806, where the legal-case-phase-management server generates an event associated with the document and stores the event in a first user database for the portfolio. As mentioned herein, events are tasks or information about a particular phase in the legal matter. For example, a document may be a transcript of a deposition, and the generated event is a time, place, and participants in the deposition. In various embodiments, the event may be automatically generated from the document using image, document, or text recognition techniques to detect known information usable to generate the event. Likewise, a plurality of events may be automatically generated when a plurality of documents are extracted from a file, as described in more detail below.

In some embodiments, events may be generated without receiving a document. For example, a graphical user interface may be provided to the first user, which allows the first user to input information that defines the event. In at least one such embodiment, block 804 is optional and may not be performed.

Process 800 proceeds next to decision block 808, where the legal-case-phase-management server determines whether another document or other event information is received, whether manually input by a user or extracted from a file. In some embodiments, the first user may upload a plurality of single documents or a single file containing a plurality of documents. Accordingly, this determination may be made in response additional inputs from the first user. In other embodiments, the first user may input a plurality of events without uploading another document. If another document is received, or if other event information is received, process 800 loops to block 806 to generate and store another event; otherwise, process 800 flows to decision block 810.

At block 810, the legal-case-phase-management server determines whether user input has been received requesting to send documents to a second user is received. In various embodiments, the first user may click on or activate a graphical user interface button to input the request, such as by clicking on the share case button 216 in FIG. 2A. In at least one embodiment, the request is to share information (whether documents or events) of the portfolio for the legal matter with the second user.

In various embodiments, the second user may be another client such that the portfolio may be copied or transferred to the other client. In some embodiments, the client name may be editable in the graphical user interface depending on the status of time entries and invoice submissions. For example, if time has been entered for the portfolio, but has not been invoiced, then the client name field in the graphical user interface may be editable. If, however, the time has been invoiced, then the client name field may be un-editable. If the name in the client name field is changed while editable, then the name change is received as the request to copy or transfer the portfolio to the new client.

If the request to send documents is received, process 800 flows to block 812; otherwise, process 800 loops to decision block 808 to continue to wait for the user to input additional documents or events.

At block 812, the legal-case-phase-management server provisions a second user database for a copy of the portfolio. In various embodiments, provisioning the second user database includes allocating memory and computing resources for the second user to access or modify the portfolio. In other embodiments, provisioning the second user database may include securing or tagging a database storage capacity sufficient to accept copies from the first user database.

Process 800 proceeds to block 814, where the legal-case-phase-management server copies the events from the first user database to the second user database. In some embodiments, the information and documents associated with each event for the portfolio are copied from the first user database to the second user database. In other embodiments, the first user may designate one or more events or documents as non-sharable, which are not copied from the first user database to the second user database.

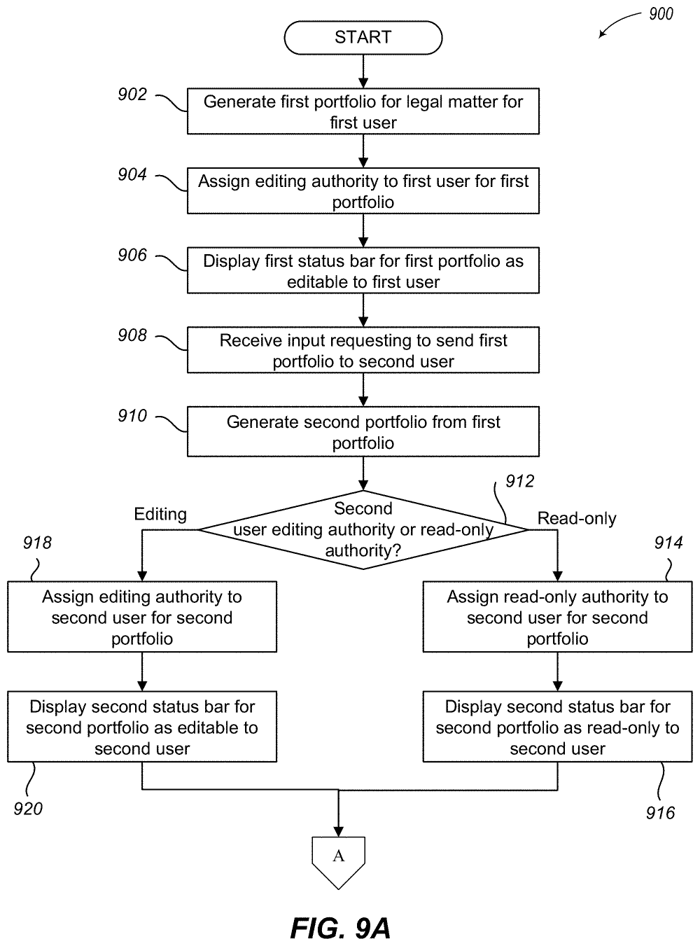

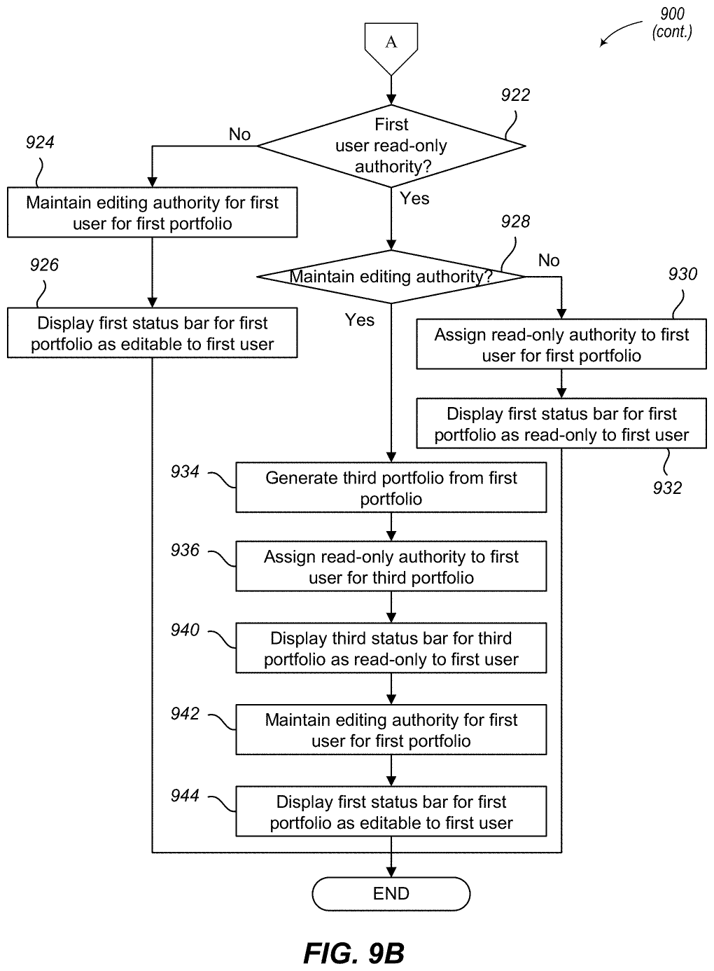

Process 800 continues at block 816, where the legal-case-phase-management server establishes access authority to the portfolio in the second user database for the second user, which is described in more detail below in conjunction with FIGS. 9A-9B. Briefly, however, a second portfolio is generated for the second user in the second user database and editing and read-only authority are determined and assigned for the first and second user based on user selection, permissions, relationships, etc.

After block 816, process 800 may terminate or otherwise return to a calling process to perform other actions. In some embodiments process 800 may loop (not illustrated) to block 804 to continue to receive documents or events for the portfolio stored in the first user database.

FIGS. 9A-9B illustrate a logical flow diagram of one embodiment of a process 900 by a legal-case-phase-management server for management editing and read-only authority of portfolios as they are shared between user in accordance with embodiments described herein. Process 900 begins, after a start block in FIG. 9A, at block 902, where the legal-case-phase-management server generates a first portfolio for a legal matter for a first user. Various embodiments for generating the first portfolio are described above in conjunction with FIG. 8, including receiving documents and generating events for the first portfolio.

Moreover, a first status bar is also generated and maintained for the first portfolio. The first status bar includes a representation of each of a plurality of phases of the legal matter for the first portfolio. Each phase representation includes one or more characteristics that can be changed depending on the status of that phase, as described above. In some embodiments, the first status bar may be optional and may not be generated or maintained for the first portfolio.

Process 900 proceeds to block 904, where the legal-case-phase-management server assigns editing authority to the first user for the first portfolio. Editing authority enables the first user to add new events, upload new documents, close events, view the first status bar, view events, etc. regarding the first portfolio.

Process 900 continues at block 906, where the legal-case-phase-management server displays the first status bar for the first portfolio to the first user. In various embodiments, the first status bar is displayed as editable to the first user because the user is assigned editing authority. Displaying the first status bar as editable enables the first user to view, modify, correct, change, remove, or otherwise access and manipulate the status bar or its corresponding events and documents. Examples of a displayed status bar are described above and illustrated in FIGS. 2A, 3A-3F, and 4. In some embodiments, block 906 may be optional and the first status bar is not displayed to the first user.

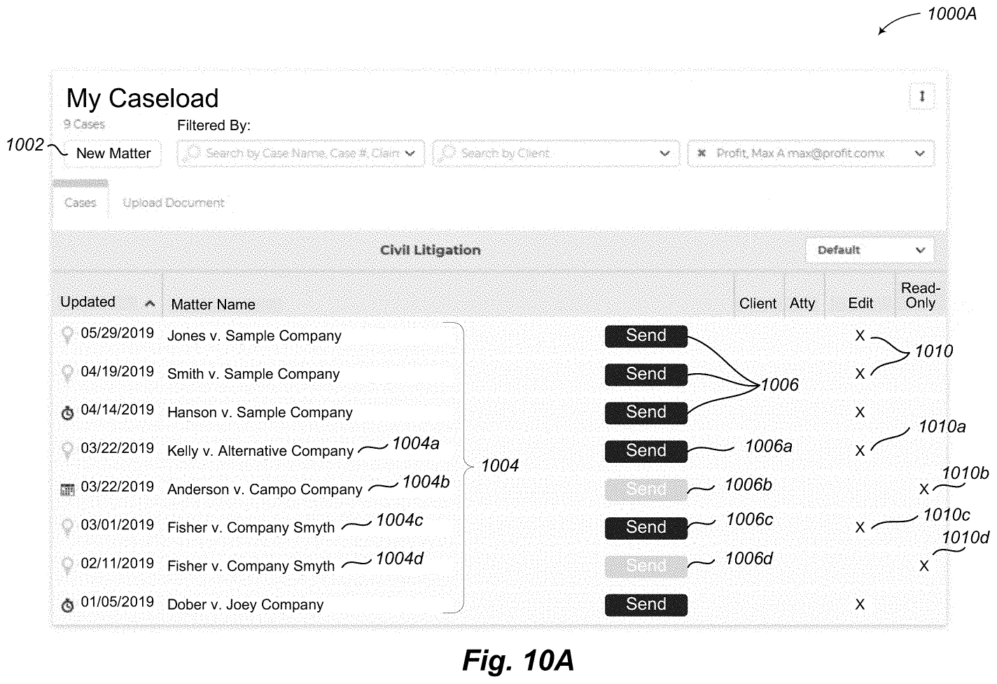

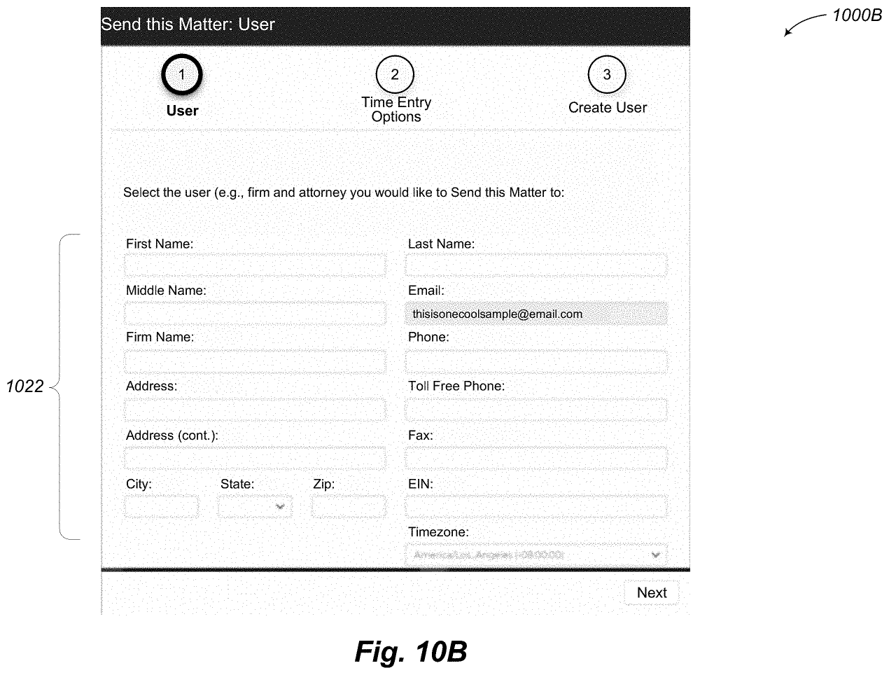

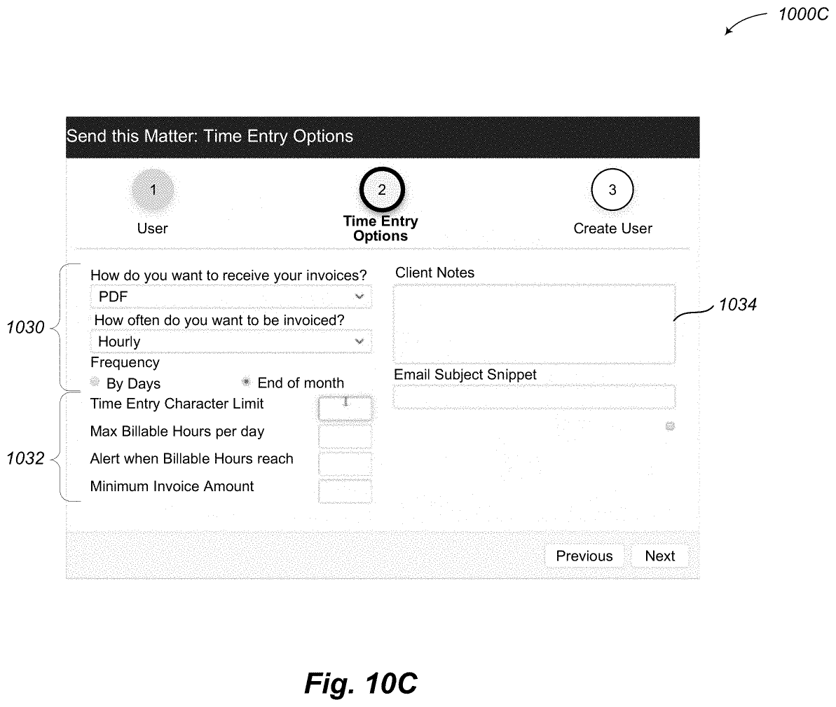

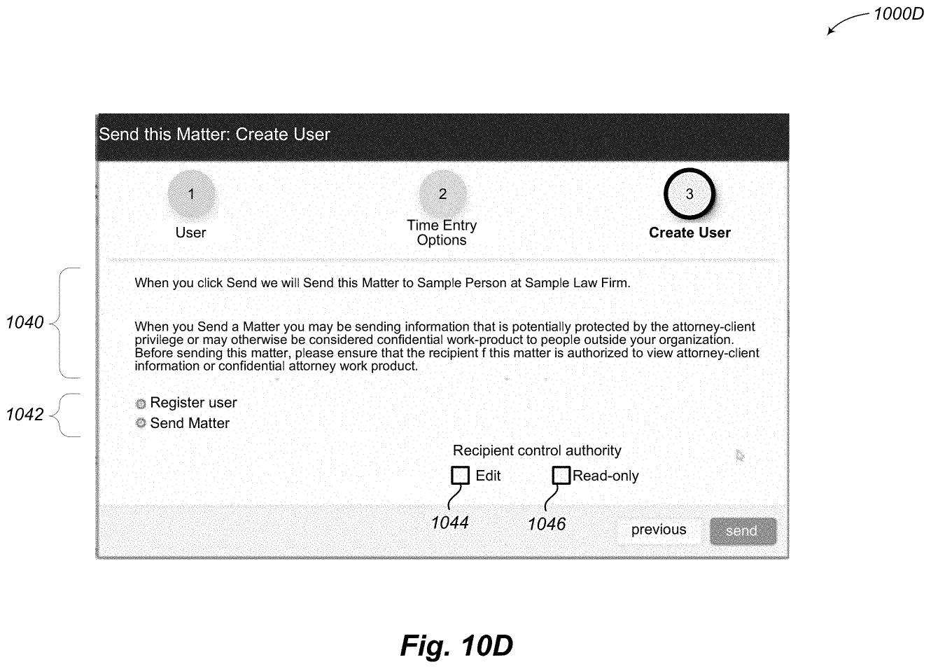

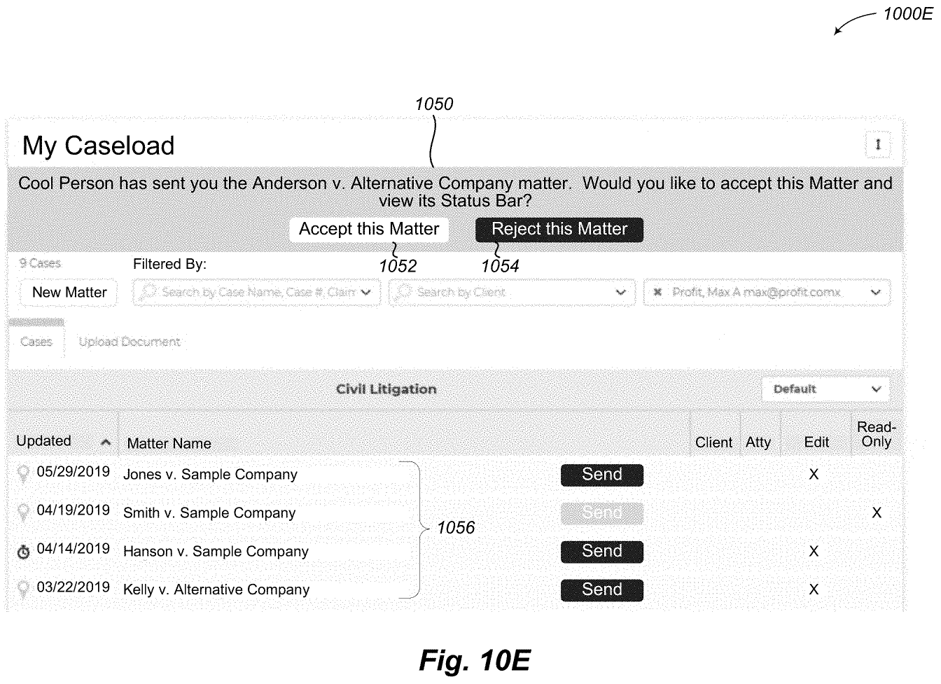

Process 900 proceeds next to block 908, where the legal-case-phase-management server receives user input requesting to send the first portfolio to a second user. In various embodiments, the first user may click on or activate a graphical user interface button to input the request, such as by clicking on the share case button 216 in FIG. 2A or send button 1006 in FIG. 10A.

Process 900 continues next at block 910, where the legal-case-phase-management server generates a second portfolio from the first portfolio. In various embodiments, generating the second portfolio includes copying the first portfolio to the second portfolio, which is similar to what is described above in conjunction with blocks 812 and 814 in FIG. 8. For example, if a database has not yet been provisioned for the second user, then a database is provisioned for the second user and the events and documents from the first portfolio for the first user are copied into the database for the second portfolio and for the second user. If, however, a database has already been provisioned for the second user (e.g., if the second user had previously received a copy of the first portfolio), then the second user portfolio is replaced or updated with the first portfolio. Moreover, in some embodiments, a second status bar is also generated and maintained for the second portfolio. In other embodiments, the second status bar is not generated and maintained for the second portfolio.

Process 900 proceeds to decision block 912, where the legal-case-phase-management server determines whether the second user is to be assigned editing authority or read-only authority to the second portfolio. The assigned authority may be selected by the first user, set by an administrator, or set based on one or more user parameters (e.g., a designated relationship between the users, whether the user is permitted to transfer or provide editing authority, etc.). In various embodiments, the request received at block 908 from the first user may indicate the editing/read-only authority of the second user. In other embodiments, a relationship between the first and second user may determine the editing/read-only authority. For example, if the first user is a client person and the second user is the client's attorney, then the second user may be assigned editing authority. Conversely, if the first user is the attorney and the second user is the client, then the second user may be assigned editing authority.

If the second user is to be assigned editing authority, then process 900 flows to block 918; otherwise, process 900 flows to block 914.

At block 914, the legal-case-phase-management server assigns the second user read-only authority for the second portfolio. In various embodiments, read-only authority permits the second user to view events and documents associated with the second portfolio. Because the second portfolio was generated from the first portfolio, the second user has access to view the events and document created by the first user in the first portfolio. However, the second user does not actually view the first portfolio and does not have authority to edit the second portfolio. The second user cannot add, modify, complete, or otherwise edit events or documents associated with the second portfolio (or the first portfolio).

Process 900 proceeds next at block 916, where the legal-case-phase-management server displays the second status bar for the second portfolio as read-only to the second user. Displaying the second status bar as read-only enables the second user to view, but not modify, correct, change, remove, or otherwise access and manipulate the status bar or its corresponding events and documents in the second portfolio. As mentioned above, in some embodiments the second status bar is not generated for the second portfolio. Accordingly, block 916 may be optional and not performed in some embodiments. After block 916, process 900 flows to decision block 922 in FIG. 9B.

If, at decision block 912 in FIG. 9A, the second user is to be assigned editing authority, then process 900 flows from decision block 912 to block 918. At block 918, the legal-case-phase-management server assigns the second user editing authority for the second portfolio. Editing authority enables the second user to add new events, upload new documents, close events, view the first status bar, view events, etc. associated with the second portfolio.

Process 900 continues next at block 920, where the legal-case-phase-management server displays the second status bar for the second portfolio as editable to the second user. Displaying the second status bar as editable enables the second user to view, modify, correct, change, remove, or otherwise access and manipulate the status bar or its corresponding events and documents in the second portfolio. In some embodiments, block 920 may be optional and may not be performed. After block 920, process 900 flows to decision block 922 in FIG. 9B.

At decision block 922, the legal-case-phase-management server determines whether the first user is to be assigned read-only authority to the first portfolio or is to maintain editing authority for the first portfolio. In various embodiments, the request to send the first portfolio to the second user at block 908 in FIG. 9A may include information or a selection as to the editing/read-only authority of the first user. Similar to decision block 912, a relationship between the first and second user may determine the editing/read-only authority of the first user for the first portfolio. For example, if the first user is a client and the second user is the client's attorney, then the client may be relinquishing editing control of the portfolio to the attorney, and access authority for first user is changed from editing authority to read-only authority. In various embodiments, the first user may obtain read-only authority so that the first user can see what was sent to the second user.

If the first user is assigned read-only authority for the first portfolio, then process 900 flows to decision block 928; otherwise, process 900 flows to block 924.

At block 924, the legal-case-phase-management server maintains editing authority for the first user for the first portfolio. Process 900 proceeds to block 926, where the legal-case-phase-management server displays the first status bar for the first portfolio as editable to the first user. In various embodiments, block 926 employs embodiments of block 906 in FIG. 9A. After block 926, process 900 terminates or otherwise returns to a calling process to perform other actions.

If, at decision block 922, the first user is to be assigned read-only authority, process 900 flows from decision block 922 to decision block 928. At decision block 928, the legal-case-phase-management server determines whether to also maintain editing authority for the first user. In various embodiments, the first user may send the first portfolio to the second user, such as at blocks 914 and 916 or at blocks 918 and 920, but the first user may have a desire to maintain a record of what was sent to the second user while maintaining editing authority of the first portfolio. In this scenario, the determination at decision block 922 is for the first user to have read-only authority of what was sent to the second user, and the determination at decision block 928 is to allow the first user to continue to edit the first portfolio. If the first user is to maintain editing authority, then process 900 flows to block 924; otherwise, process 900 flows to block 930.

At block 930, the legal-case-phase-management server assigns the first user read-only authority for the first portfolio. In various embodiments, read-only authority permits the first user to view events and documents associated with the first portfolio, but the first user no longer has authority to edit the first portfolio. The first user cannot add, modify, complete, or otherwise edit events or documents associated with the first portfolio (or the second portfolio sent to the second user).

Process 900 continues next at block 932, where the legal-case-phase-management server displays the first status bar for the first portfolio as read-only to the first user. Displaying the first status bar as read-only enables the first user to view, but not modify, correct, change, remove, or otherwise access and manipulate the status bar or its corresponding events and documents in the first portfolio. After block 932, process 900 terminates or otherwise returns to a calling process to perform other actions.

If, at decision block 928, the first user is to also maintain editing authority, process 900 flows from decision block 928 to block 934. At block 934, the legal-case-phase-management server generates a third portfolio from the first portfolio. In various embodiments, generating the third portfolio includes copying the first portfolio to the third portfolio, which is similar to what is described above in conjunction with blocks 812 and 814 in FIG. 8, but in the same first user database of the first user. Moreover, a third status bar is also generated and maintained for the third portfolio.

Process 900 continues at block 936, where the legal-case-phase-management server assigns read-only authority to the first user for the third portfolio. In various embodiments, read-only authority permits the first user to view events and documents associated with the third portfolio, but the first user does not have authority to edit the third portfolio. The first user cannot add, modify, complete, or otherwise edit events or documents in the third portfolio. In this way, the first user can see what the portfolio looked like when it was sent to the second user. In some embodiment, the third portfolio may be synchronized with the second portfolio so that the first user can see edits made by the second user to the second portfolio.

Process 900 proceeds to block 940, where the legal-case-phase-management server displays the third status bar of the third portfolio as read-only to the first user, which is similar what is described at block 932—but for the third status bar.

Process 900 continues next at block 942, where the legal-case-phase-management server maintains editing authority for the first user for the first portfolio, which is similar to what is described at block 924.

Process 900 proceeds next to block 944, where the legal-case-phase-management server displays the first status bar for the first portfolio as editable to the first user, which is similar to what is described at block 926.

After block 944, process 900 terminates or otherwise returns to a calling process to perform other actions.

In various embodiments, the second user may be permitted to share the second portfolio with other users. For example, if the second user is assigned editing authority for the second portfolio at block 918, then the second user may be able to share the second portfolio with a third user. In at least one such embodiment, the system may perform similar embodiments to what is described in FIG. 9 to generate a third portfolio for the legal matter and assign editing or read-only authority to the third user.

Although process 900 describes the generation of a second portfolio to be shared with a second user, embodiments are not so limited. In some embodiments, the read-only authority for the first portfolio may be assigned to a second user. In this way, a second user can view the first portfolio for the legal matter for the first user and see changes made by the first user. In other embodiments, editing authority for the first portfolio may be assigned to the second user, which allows the second user to view and change the first portfolio for the legal matter similar to how the first user views and changes the first portfolio. In at least one such embodiment, the first user may assign sub-permissions that give the second user editing authority but restricts the editing of some aspects of the first portfolio, such as deleting the portfolio or sharing the portfolio with a third user.

FIGS. 10A-10E illustrate use case example screenshots of a graphical user interface in accordance with embodiments described herein. FIG. 10A illustrates a use case example screenshot of a graphical user interface 1000A that presents a plurality of portfolios 1004 to a user, which may collectively be referred to as the user's caseload. The user can click on any one of the portfolios 1004 to view a status bar, events, or other details regarding a particular portfolio, which is described above and illustrated in FIG. 2A.

The interface 1000A also includes a send buttons 1006 for each corresponding portfolio 1004. For example, a user can initiate the sending of portfolio 1004a to another user by clicking on the send button 1006a. In some illustrative examples, clicking on the send button 1006a opens another window or interface in which the user can enter information regarding the recipient user of the portfolio 1004a, which is illustrated in FIG. 10B.

The interface 1000A also includes an assigned authority 1010 to the user for each of the plurality of portfolios 1004, as described herein. For example, the user has been assigned editing authority 1010a for portfolio 1004a, but read-only authority 1010b for portfolio 1004b. In various embodiments, the user cannot send a portfolio that is read-only, such as illustrated by the greyed-out send button 1006b. In other embodiments, the user can share a read-only portfolio, but on a read-only basis. In this illustrative example, portfolio 1004b may have been shared with another user such that editing authority was transferred to the other user. Alternatively, portfolio 1004b may have been received from another user such that the user only has read-only authority 1010b. Although not illustrated, the interface 1000A may include other information to indicate whether a portfolio 1004 was sent from the user or received from another user.

As described herein, a user may share a portfolio with another user while maintaining editing authority. In some such embodiments, an additional portfolio is generated for the user as a read-only copy so that the user can see the status of the portfolio when sent to the other user (or as edited by the other user). For example, the user may have previously shared portfolio 1004c, which resulted in the generation of copied portfolio 1004d. As illustrated, the user is assigned read-only authority 1010d for the copied portfolio 1004d, but has maintained editing authority 1010c for the original portfolio 1004c. The user can again send portfolio 1004c by clicking on the send button 1006c, but cannot send the copied portfolio 1006d by clicking on the send button 1006d.

FIG. 10B illustrates a use case example screenshot of a graphical user interface 1000B that is presented to a user in response to the user selecting to share or otherwise send a portfolio of a legal matter to another user. The interface 1000B includes a plurality of input boxes 1022 for the user to input information regarding the recipient user. If the recipient user is an existing user of other portfolios, then only their email address may be provided. Otherwise, the system may require the user to input additional information regarding the recipient user to initiate a database for the recipient user.

After the sending user has input information regarding the recipient user and clicked “next,” another graphical user interface 1000C in FIG. 10C may be presented to the user. The interface 1000C enables the sending user to input one or more pieces of information regarding a billing or time entry relationship between the sender and the recipient. For example, the user may input various information 1030 regarding type and frequency of invoices or other information 1032 regarding particular timing, billing, or time entry parameters. The interface 1000C may also include a user notes input box 1034 to allow the sending user to input further information regarding the legal matter or portfolio, billing or time entry setup, relationship between the users, etc.

After the sending user has input billing, time entry, or invoice information and clicked “next,” another graphical user interface 1000D in FIG. 10D may be presented to the user. For example, the interface 1000D may present a warning 1040 to the sending user indicating that the information about to be shared is potentially protected by the attorney-client privilege or may otherwise be considered confidential. The interface 1000D can also include information 1042 in which the sending user is informed that the recipient user has been successfully registered as a user (e.g., a database for the recipient user has been generated to accept a copy of the portfolio being shared) and that the portfolio of the legal matter is ready to be sent to the recipient.

Interface 1000D may also include option boxes 1044 and 1046. Selection of option box 1044 may assign edit authority to the recipient user for the portfolio. Selection of option box 1046 may assign read-only authority to the recipient user for the portfolio, as further described above. After the sending user clicks “send”, a notice is provided to the recipient user indicating that a portfolio is being sent to them from another user, which is illustrated in FIG. 10E.

FIG. 10E illustrates a use case example screenshot of a graphical user interface 1000E that is presented to a recipient user in response to the sending user sending a portfolio of a legal matter to the recipient user. Interface 1000E may be similar to what is illustrated in FIG. 10A, but with the addition of notice 1050. The notice 1050 indicates that a portfolio for a new legal matter is being sent to the user from another user. The notice 1050 also includes an accept button 1052 and a rejection button 1054. If the accept button 1052 is clicked, the new portfolio is added to the user's list of portfolios 1056. If, however, the user clicks the reject button 1054, then the new portfolio is not added to the list of portfolios 1056 for the user and a notification is sent to the sending user indicating that the portfolio has been rejected, such as if the incorrect portfolio was sent.

The example interfaces shown in FIGS. 10A-10E are for illustrative purposes and may be different in look and the amount of information requested from or shown to the user.

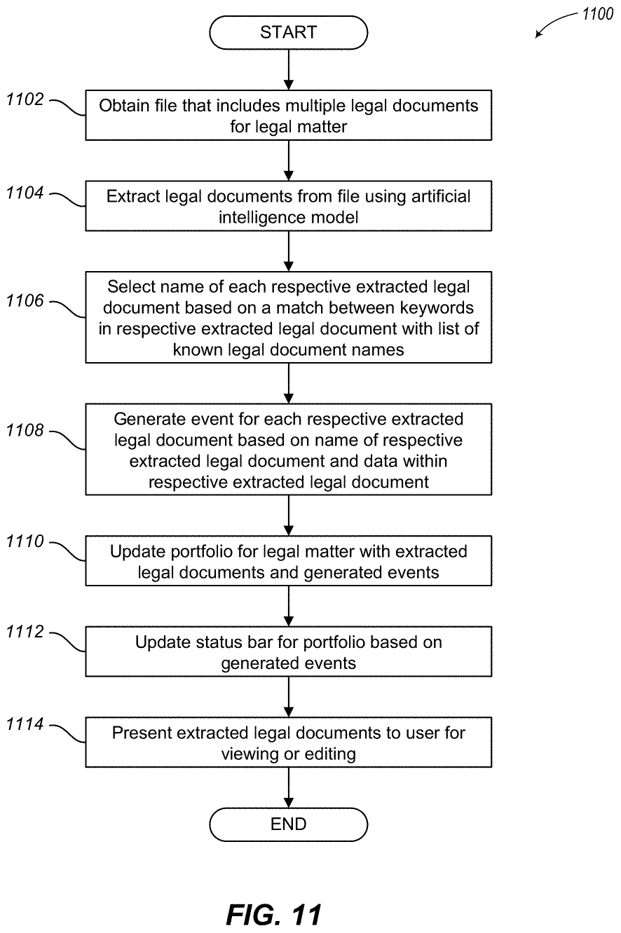

The operation of other aspects will now be described with respect to FIGS. 11-13. Processes 1100, 1200, and 1300 described in conjunction with FIGS. 11-13, respectively, may be implemented by or executed on one or more computing devices, such as the legal-matter-phase-management server 102 in FIG. 1, or another computing device (not illustrated) remote to the legal-matter-phase-management server 102.

FIG. 11 is a logical flow diagram of one embodiment of a process 1100 by a legal-case-phase-management server for extracting legal documents for a legal matter in accordance with embodiments described herein. Process 1100 begins, after a start block, at block 1102, were a file that includes a plurality of legal documents is obtained. The file may be downloaded to the legal-matter-phase-management server 102, such as via email, document sharing website, a court or municipality or agency document portal, etc., or the file may be uploaded to the legal-matter-phase-management server 102, such as from a USB drive, a user computer, etc.

The file may include a plurality of the same type of documents or multiple types of documents. For example, the file may include court or agency filed documents (e.g., motions), hearing schedules, court or agency orders or correspondence, exhibits or evidence, client correspondence, emails, or other documents. The types of documents in a file may be specific to a particular legal matter type. For example, in a workers compensation proceeding the file may include employment records, doctor evaluations, court orders, etc., whereas in a patent application proceeding the file may include the draft application, office actions, or other correspondence between the applicant and the U.S. Patent and Trademark Office. Although the file is described as including a plurality of documents, embodiments are not so limited. Rather, in some embodiments, the file may include a single document. For example, if the file includes a single document of an unknown type, utilization of embodiments described herein to extract the document may identify the document type and label it appropriately.

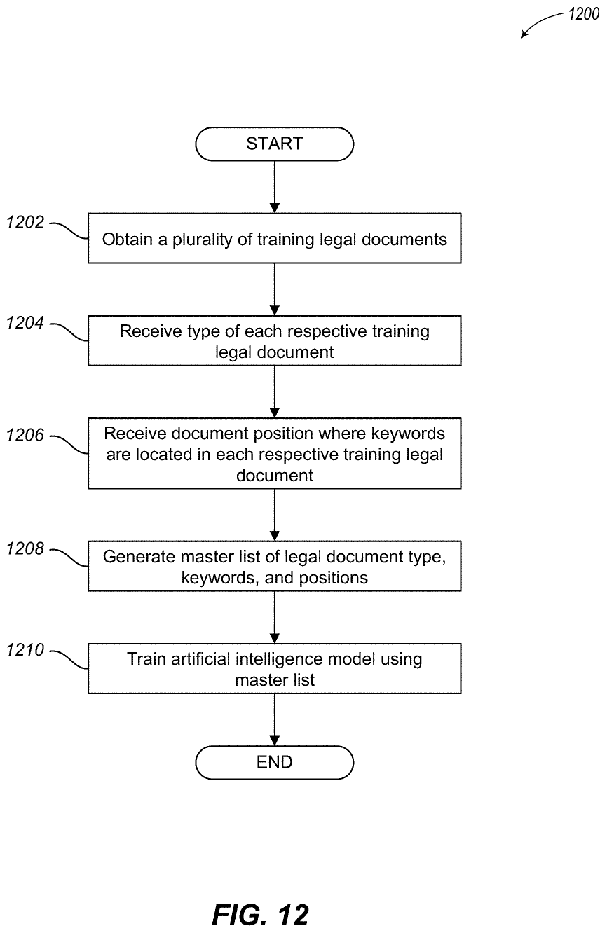

Process 1100 proceeds to block 1104, where the plurality of legal documents are extracted from the file using an artificial intelligence model. In various embodiments, an artificial intelligence model is generated from a plurality of training documents, which is discussed in more detail below in conjunction with FIG. 12. The artificial intelligence model may be employed using one or more of a number of different artificial intelligence algorithms, including, but not limited to, logistic regression, support vector machines, k nearest neighbours, random forest, support vector machines, neural networks, or other machine learning or artificial intelligence learned mechanisms.

In at least one embodiment, each separate document is identified in the file based on specific information identified in a header or on the first page (or some other specified page) of a document. Accordingly, in some embodiments, the artificial intelligence model is used to identify the first page of each identifiable document. The first page and the subsequent pages that precede the first page of the next identifiable document are extracted or copied from the file and put into a new file. In various embodiments, each extracted document is a new individual file of one or more pages identified as being part of a single document. For example, each new file may be in pdf format of a single document.

In some embodiments, the artificial intelligence model is selected from a plurality of artificial intelligence models based on the particular legal matter type associated with the file. In at least one embodiment, the user may select the legal matter type or corresponding artificial intelligence model for that legal matter type. For example, a first artificial intelligence model may be selected for a file of documents associated with a workers compensation case, whereas a second artificial intelligence model may be selected for a file of documents associated with a patent application prosecution. In this example, the first and second artificial intelligence models may be different because the training documents used to train the models may have different identifiable characteristics.

In other embodiments, the artificial intelligence model is selected from a plurality of artificial intelligence models based on the venue or jurisdiction (e.g., court, municipality, agency, etc.) of the legal matter associated with the file. For example, a first artificial intelligence model may be selected for a file of documents associated with a legal matter in Washington State Superior Court, and a second artificial intelligence model may be selected for a file of documents associated with a legal matter in the United States Court of Appeals for the Federal Circuit. In this example, the first and second artificial intelligence models may be the same or they may be different depending on how similar the training documents are between the two courts.

In various embodiments, the artificial intelligence model may be selected from a plurality of artificial intelligence models based on a combination of the legal matter type and the venue or jurisdiction.

Process 1100 continues at block 1106, where a name of each respective extracted legal document is selected based on a match between keywords in the respective document and a list of known legal document names. In some embodiments, the name of a document is identified and selected as the document is being identified and extracted by the artificial intelligence model.

The keywords may be words on a title page, in a heading, or on a first page of the document or they may be words within a specific area or at a specific location on a specific page in the document. For example, the artificial intelligence model may indicate that a summary judgment motion is identifiable by the words “summary judgment” inside an area that is 10 cm wide by 2 cm high, centered 8 cm from the top of the first page of the document. If “summary judgment” is located in this area, then the document name is selected as “summary judgment motion” and is extracted, along with the subsequent pages until another identifiable document, from the file. As another example, a document may be extracted based on the page numbering (e.g., by starting at page 1). The first page of this document may be scanned (or a portion or selected area of the first page may be scanned) for words, and those words are compared to each word in the list of known legal document names. If there is a match, then the scanned word or corresponding document name is selected as the document name.

In some embodiments, the selected document name may be unknown if the document does not include a keyword that matches a name within the list of known legal document names.

Process 1100 proceeds next to block 1108, where an event for each respective extracted legal document is generated. In various embodiments, each event is generated based on the name of the respective extracted legal document and data within the respective document. For example, if the selected document name is “notice to appear,” then the document may be scanned for the date of when the party is to appear. The event to appear in court is generated with the date identified in the document. If no date is identified, then the event may still be generated and the user may be notified of the missing date or prompted to enter a date. Other information regarding the event may be also obtained, including legal matter phase, event type, or event title. The events may then be utilized to generate a status bar as described herein.

Process 1100 continues next at block 1110, where a portfolio for the legal matter is updated with the extracted legal documents and generated events, as described elsewhere herein. Moreover, in some embodiments, the particular legal matter assigned to extracted legal documents is selected prior to document extraction such that each extracted legal document is assigned to the selected legal matter. In other embodiments, the legal matter assigned to each extracted legal document is selected after the legal documents are extracted. In at least one embodiment, a user may assign one or more legal matters to an extracted legal document such that the extracted legal document is copied and included with each selected legal matter. For example, if the extracted legal document is an email that pertains to multiple legal matters, then the extracted email is copied into each legal matter identified in the email.

Process 1100 proceeds to block 1112, where a status bar for the portfolio is updated based on the generated events, as described elsewhere herein.

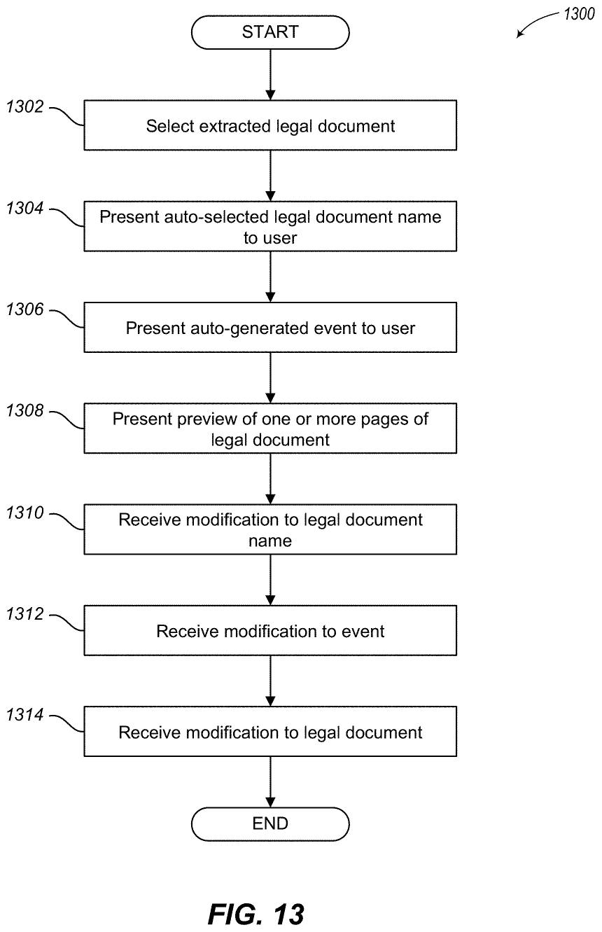

Process 1100 continues at block 1114, where the extracted legal documents are presented to a user for viewing or editing, which is described in more detail below in conjunction with FIG. 13. Briefly, however, a list or thumbnail representations of the extracted documents and their selected names may be displayed to the user. The user can click on and select an extracted document to see the pages of the selected document and edit the document or name of the document.

After block 1114, process 1100 terminates or otherwise returns to a calling process to perform other actions.

FIG. 12 is a logical flow diagram of one embodiment of a process 1200 by a legal-case-phase-management server for employing a master list of documents for training an artificial intelligence model for legal document extraction in accordance with embodiments described herein. Process 1200 begins, after a start block, at block 1202, where a plurality of training legal documents are obtained. In various embodiments, a user uploads or provides the plurality of training legal documents. In some embodiments, the training documents are labeled for a particular jurisdiction or legal matter type.

Process 1200 proceeds to block 1204, where a type of each training document is received. In various embodiments, training documents are labeled with a particular name that indicates the type of legal document, such as “summary judgment motion,” “employment record,” “patent application,” etc.

Process 1200 continues at block 1206, where a document position is received indicating where keywords are located in each respective training document. The document position may be referred to as an area-of-interest. For example, one document may be labeled as having an area-of-interest positioned in the upper right corner and is 5 cm wide and 3 cm high. Another document may be labeled as having an area-of-interest positioned in the center of page two and is 7 cm wide and 4 cm high.

In some embodiments, an area-of-interest may be defined without being associated with a particular keyword or keyword type. In other embodiments, an area-of-interest may define a particular keyword or keyword type to be found in that area-of-interest. For example, a legal document may include a first area-of-interest on page one and a second area-of-interest also on page one. The first area-of-interest may indicate, for example, the keyword “Washington Superior Court” (a particular keyword) and the second area-of-interest may indicate a party's name (a keyword type).

Process 1200 proceeds next to block 1208, where a master list of legal document type or name, keywords, and corresponding positions is generated. In some embodiments, the master list is in a table format where the first column includes the document type, the second column includes a keyword (or keyword type) to be found in the document type, and the third column includes the position or defined area-of-interest where the keyword is to be found in the document type, where each row is a separate corresponding combination of document type, keyword, and document position. It should be recognized that other column orders or database schemes may also be employed.

In some embodiments, a separate master list may be generated for each separate venue or jurisdiction (or subset) of a plurality of venues or jurisdictions. In other embodiments, a separate master list may be generated for each separate legal matter type (or subset) of a plurality of legal matter types. In yet other embodiments, separate master lists may be generated for different combinations of venue and legal matter type.

Process 1200 continues next at block 1210, where the artificial intelligence model is trained using the master list. In various embodiments, one or more artificial neural networks or other artificial intelligence training algorithms or mechanisms may be utilized to train the artificial intelligence model. In some embodiments, the training legal documents may be provided as input to the training algorithm to train the model. But in other embodiments, the information in the master list (document type or name, keyword, position combinations) is provided as input to the training algorithm to train the model. Because multiple master lists may be made for different venues or legal matter types, multiple artificial intelligence models may be generated.

After block 1210, process 1200 may terminate or otherwise return to a calling process to perform other actions.

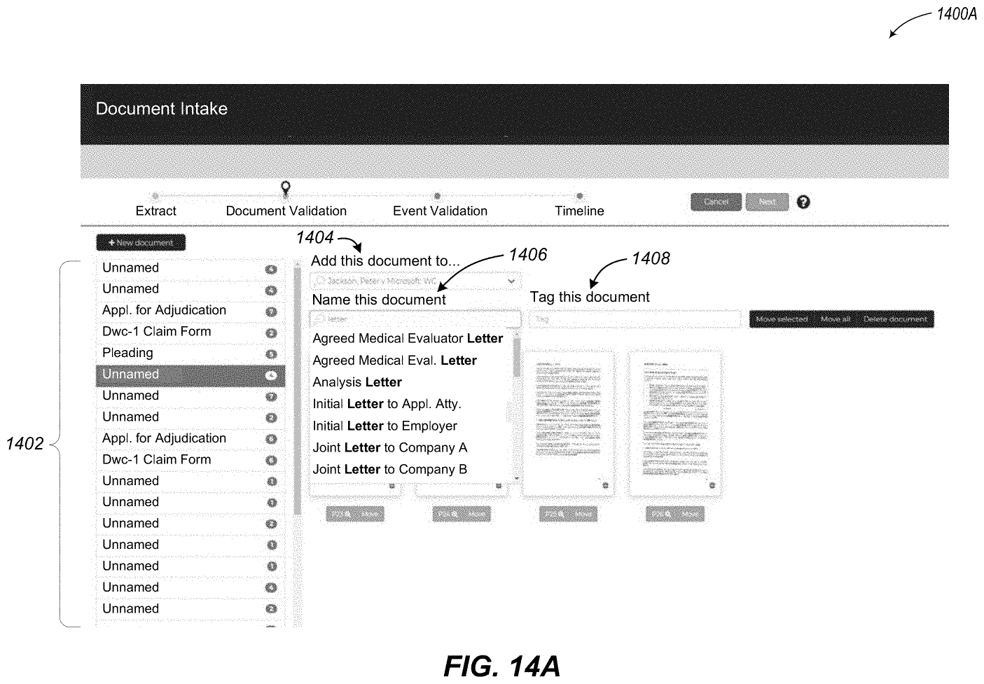

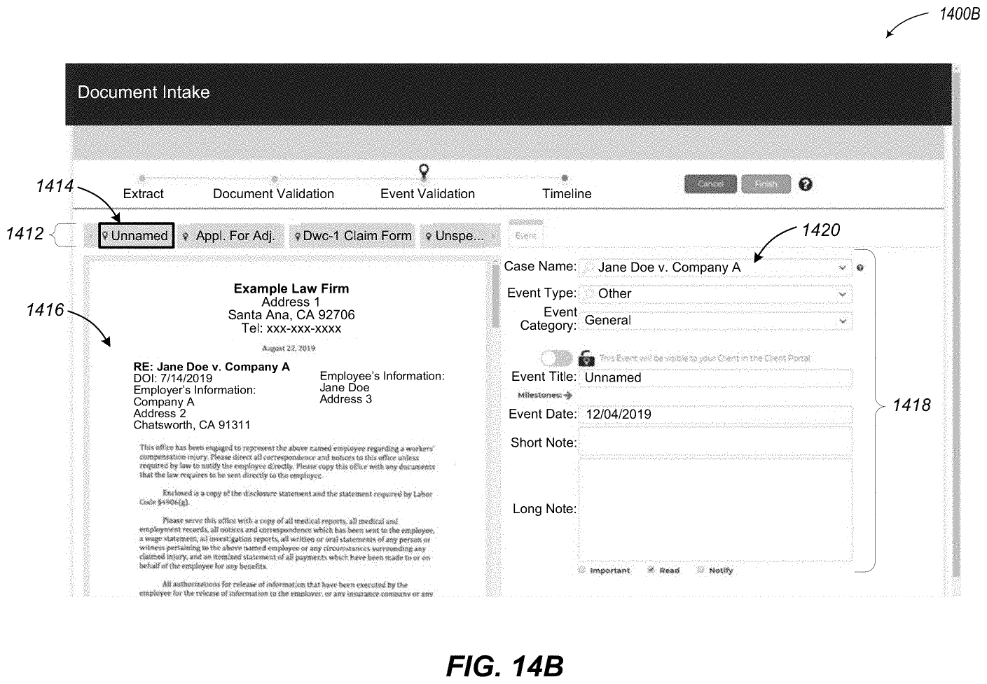

FIG. 13 is a logical flow diagram of one embodiment of a process 1300 by a legal-case-phase-management server for generating and modifying extracted documents and events in accordance with embodiments described herein. Process 1300 begins, after a start block, at block 1302, where an extracted legal document is selected. In some embodiments, a list or thumbnail representations of one or more extracted documents, such as legal documents extracted by process 1100 in FIG. 11, may be displayed to a user via a graphical user interface. In some embodiments, the user can click on and select a specific extracted document. In other embodiments, an extracted document may be automatically selected, such as if it was the first document extracted from the file or has a most recent date. One use case example, of a graphical user interface where a user can select an extracted legal document is illustrated in FIG. 14.

Process 1300 proceeds to block 1304, where an auto-selected name for the selected legal document, such as automatically selected at block 1106 in FIG. 11, is presented to the user via the graphical user interface. One use case example, of a graphical user interface that presents the extracted legal document name is illustrated in FIG. 14.

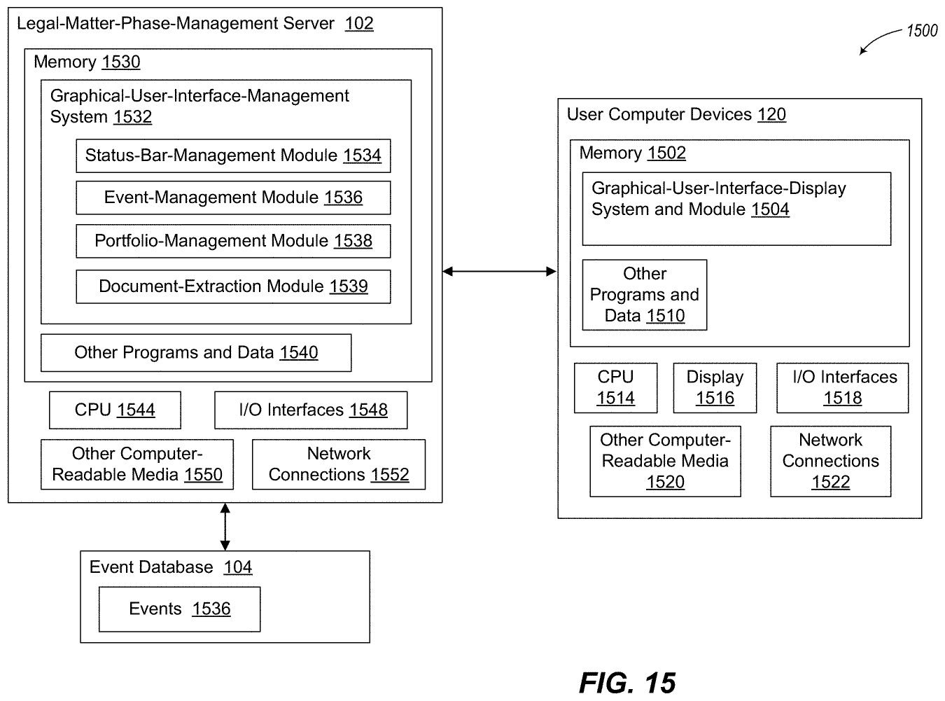

Process 1300 continues at block 1306, where one or more auto-generated events for the selected legal document, such as automatically generated at block 1108 in FIG. 11, are presented to the user via the graphical user interface. One use case example, of a graphical user interface that presents the auto-generated event for an extracted legal document is illustrated in FIG. 15.

Process 1300 proceeds next to block 1308, where a preview of one or more pages of the legal document are presented to the user. In various embodiments, a window or viewing pane in the graphical user interface may display the extracted legal document. In some embodiments, only a first page of the extracted legal document is displayed. In other embodiments, the extracted legal document is displayed as separate pages. In yet other embodiments, the extracted legal document is displayed such that the user can scroll from one page to the next. One use case example, of a graphical user interface that presents a preview of the extracted legal document is illustrated in FIG. 15.

Process 1300 continues next at block 13010, where a modification to the legal document name is received. In some embodiments, the user can manually type in, correct, or otherwise change the legal document name via the graphical user interface. In other embodiments, the user may utilize a dropdown menu or other graphical interface to select a previously used or system defined legal document name.

Process 1300 proceeds at block 1312, where a modification to the event is received. In various embodiments, the user can change the event title, the event date, add one or more notes associated with the event, etc. via the graphical user interface.

Process 1300 continues at block 1314, where one or more modifications to the legal document are received. In various embodiments, the user can rearrange the pages of the document, delete one or more pages of the document, extract one or more pages of the document as a new legal document, etc. via the graphical user interface.

After block 1314, process 1300 terminates or otherwise returns to a calling process to perform other actions.

FIGS. 14A-14B illustrate use case example screenshots of a graphical user interface showing extracted documents and events in accordance with embodiments described herein. In some embodiments, the document extraction process may begin when a user selects an extract documents button while in a particular matter, such as by selecting extract documents button 218 in interface 200B in FIG. 2B. In other embodiments, the user can select an extract documents button that is not associated with a particular matter.

FIG. 14A illustrates a use case example screenshot of a graphical user interface 14A that presents a list of extracted legal documents and their names to a user. In particular, interface 1400A includes a list 1402 of each extracted document. A user can select one of the extracted legal documents by clicking on its entry or document name in the list 1402.

Input box 1406 displays the name of the selected legal document. In some embodiments, a user can manually type in a document name in the input box 1406 or select from a dropdown menu of previously used or defined document names. In other embodiments, the input box 1406 may include the auto-selected name for the selected legal document.

The interface 1400A may also include input boxes 1404 and 1408. Input box 1404 enables the user to add the legal document to a particular case or legal matter as described herein. And input box 1408 enables a user to add metadata tags or other information to the legal document.

FIG. 14B illustrates a use case example screenshot of a graphical user interface 1400B that displays an event for the selected legal document to a user. Interface 1400B includes a preview 1416 of a selected document 1414. The interface 1400B also includes a list 1412 of the extracted legal documents from which the user can select a specific legal document to preview. The interface 1400B also includes event details 1418, which may include a case or matter name, event type, event category, event title, event date, and one or more notes. As described herein, an event may be automatically generated based on information contained within the extracted legal document. This auto-generated event information may be displayed in the event details 1418. In some embodiments, a user can manually enter or modify the auto-generated event details via one or more input boxes in the event details 1418.

As mentioned above, the document extraction process may begin from a particular matter or independent of a particular matter. If the document extraction process is initiated from a particular matter, then a case name 1420 may be assigned to each extracted legal document based on the initiating matter. If the document extraction process is initiated without being associated with a particular matter, then a user can type in or use a drop-down menu to select the case name 1420 for each extracted legal document identified in list 1412. In some embodiments, the user may select a separate case name 1420 for each separate extracted legal document. In other embodiments, the user may select a single case name 1420 to be assigned to a plurality of extracted legal documents. In at least one embodiment, the list 1414 may include an identifier or symbol, such as a dropper icon, to indicate that a particular extract legal document has been assigned to a legal matter.

The example interfaces shown in FIGS. 14A-14B are for illustrative purposes and may be different in look and the amount of information requested from or shown to the user.

FIG. 15 shows a system diagram that describes one implementation of computing systems for implementing embodiments described herein. System 1500 includes legal-matter-phase-management server 102, event database 104, and user computer devices 120.

One or more special-purpose computing systems may be used to implement legal-matter-phase-management server 102 to generate and present a status bar to a user of a user computer device 120 via a graphical user interface, as described herein. Accordingly, various embodiments described herein may be implemented in software, hardware, firmware, or in some combination thereof.

The legal-matter-phase-management server 102 includes memory 1530, one or more central processing units (CPUs) 1544, I/O interfaces 1548, other computer-readable media 1550, and network connections 1552. The legal-matter-phase-management server 102 may include other computing components that are not shown for ease of illustration.

Memory 1530 may include one or more various types of non-volatile and/or volatile storage technologies. Examples of memory 1530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 1530 is utilized to store information, including computer-readable instructions that are utilized by CPU 1544 to perform actions and embodiments described herein.

For example, memory 1530 may have stored thereon graphical-user-interface-management system 1532. Graphical-user-interface-management system 1532 includes status-bar-management module 1534, event-management module 1536, portfolio-management module 1538, and document-extraction module 1539 to employ embodiments described herein. For example, the status-bar-management module 1534 generates a status bar for a legal matter. The status bar includes a representation of each of a plurality of phases of the legal matter and a marker associated with a phase that includes a most recent event. The event-management module 1536 generates and displays events to the user. The portfolio-management module 1538 generates copy portfolios for users and assigns edit/read-only authority based on how the portfolio is shared. The document-extraction module 1539 extracts one or more legal documents from a file, selects a name for the extracted legal documents, and generates events associated with the extracted legal document. The status-bar-management module 1534, the event-management module 1536, the portfolio-management module 1538, the document-extraction module 1539 or any combination thereof, may interact with other computing devices, such as event database 104 to store and retrieve event information or a user computer device 120 to present the graphical user interface described herein to a user. Although illustrated separately, the functionality of the status-bar-management module 1534, the event-management module 1536, the portfolio-management module 1538, and the document-extraction module 1539 may be performed by a single module or multiple modules. Memory 1530 may also store other programs and data 1540 to perform other actions associated with the operation of legal-matter-phase-management server 102.

Network connections 1552 are configured to communicate with other computing devices, such as user computer devices 120 or other devices not illustrated in this figure. In various embodiments, the network connections 1552 include transmitters and receivers (not illustrated) to send and receive data as described herein. I/O interfaces 1548 may include a keyboard, audio interfaces, video interfaces, or the like. Other computer-readable media 1550 may include other types of stationary or removable computer-readable media, such as removable flash drives, external hard drives, or the like.

User computer devices 120 receive information from the legal-matter-phase-management server 102 to present to a user the graphical user interface and legal matter status bar as described herein. Users can interact with the graphical user interface such that the user computer devices 120 provide information to the legal-matter-phase-management server 102 regarding such interactions. One or more special-purpose computing systems may be used to implement each user computer device 120. Accordingly, various embodiments described herein may be implemented in software, hardware, firmware, or in some combination thereof.

User computer devices 120 may include memory 1502, one or more central processing units (CPUs) 1514, display 1516, I/O interfaces 1518, other computer-readable media 1520, and network connections 1522. Memory 1502 may include one or more various types of non-volatile and/or volatile storage technologies, similar to what is described above for memory 1530.

Memory 1502 is utilized to store information, including computer readable instructions that are utilized by CPU 1514 to perform actions. In some embodiments, memory 1502 may have stored thereon graphical-user-interface-display system and module 1504, which presents the graphical user interface and legal matter status bar on display 1516 based on information received from legal-matter-phase-management server 102. Memory 1502 may also store other programs and data 1510 to perform other actions associated with the operation of user computer device 120.

Display 1516 is configured to provide content to a display device for presentation of the graphical user interface to a user. In some embodiments, display 1516 includes the display device, such as a television, monitor, projector, or other display device. In other embodiments, display 1516 is an interface that communicates with a display device.

I/O interfaces 1518 may include a keyboard, audio interfaces, video interfaces, or the like, which may be configured to enable a user to interact with the graphical user interface described herein. Network connections 1522 are configured to communicate with other computing devices, such as legal-matter-phase-management server 102 or other computing devices not illustrated in this figure. In various embodiments, the network connections 1522 include transmitters and receivers (not illustrated) to send and receive data as described herein. Other computer-readable media 1520 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining a file for a portfolio for a legal matter, wherein the file includes a plurality of legal documents;
extracting the plurality of legal documents from the file using an artificial intelligence model;
selecting a name for each respective extracted legal document of the plurality of extracted legal documents based on a match between keywords in the respective extracted legal document and a list of known legal document names;
generating an event for each respective extracted legal document based on the name of the respective extracted legal document and data within the respective legal document;
updating the portfolio for the legal matter with the plurality of extracted legal documents and the generated events; and
presenting the plurality of extracted legal documents and the generated events to a user.

2. The method of claim 1, wherein the event for each respective extracted legal document includes a date and a title regarding a task or information about a particular phase in the legal matter.

3. The method of claim 1, wherein generating the event for each respective extracted legal document includes:
determining a type and category for the event based on the name of the respective extracted legal document; and
determining a date of the event based on the data within the respective legal document.

4. The method of claim 1, further comprising:
training the artificial intelligence model from a plurality of training legal documents.

5. The method of claim 4, wherein training the artificial intelligence model includes:
receiving a type of each respective training legal document of the plurality of training legal documents;
receiving a document position for each respective training legal document where one or more keywords are located in the respective training legal document; and
analyzing the plurality of training legal documents, the type of each respective training legal document, and the document position of the one or more keywords located in each respective training legal document using one or more artificial intelligence training mechanisms to train the artificial intelligence model.

6. The method of claim 4, wherein training the artificial intelligence model includes:
receiving a type of each respective training legal document of the plurality of training legal documents;
receiving a document position for each respective training legal document where one or more keywords are located in the respective training legal document;
generating a master list that includes the type of each respective training legal document and the document position of the one or more keywords located in each respective training legal document; and
analyzing the master list using one or more artificial intelligence training mechanisms to train the artificial intelligence model.

7. The method of claim 1, wherein presenting the plurality of extracted legal documents and the generated events to the user includes:
selecting a legal document from the plurality of extracted legal documents;
presenting the name of the selected legal document to the user;
presenting the event for the selected legal document to the user; and
presenting a preview of one or more pages of the selected legal document to the user.

8. The method of claim 7, further comprising:
receiving a modification to one or more of the name of the selected legal document, the event for the selected legal document, or one or more pages of the selected legal document; and
updating the portfolio for the legal matter based on the received modification.

9. The method of claim 1, further comprising:
selecting the legal matter prior to extraction of the plurality of legal documents from the file; and
assigning each respective extracted legal document to the selected legal matter.

10. The method of claim 1, further comprising:
selecting the legal matter for one or more of the plurality of extract legal documents after extraction from the file; and
assigning each of the one or more extracted legal documents to the selected legal matter.

11. A non-transitory computer-readable storage medium having stored thereon instructions that, when executed by a processor, cause the processor to perform actions, the actions comprising:
obtaining a file associated with a portfolio for a legal case, wherein the file includes a plurality of legal documents;
extracting the plurality of legal documents from the file using an artificial intelligence model;
selecting a name for each respective extracted legal document of the plurality of extracted legal documents based on a match between keywords in the respective extracted legal document and a list of known legal document names;
generating an event for each respective extracted legal document based on the name of the respective extracted legal document and data within the respective legal document;
updating the portfolio for the legal case with the plurality of extracted legal documents and the generated events; and
presenting the plurality of extracted legal documents and the generated events to a user.

12. The non-transitory computer-readable storage medium of claim 9, wherein execution of the instructions by the processor to generate the event for each respective extracted legal document, cause the processor to perform further actions, the further actions comprising:
determining a type and category for the event based on the name of the respective extracted legal document; and
determining a date of the event based on the data within the respective legal document.

13. The non-transitory computer-readable storage medium of claim 12, wherein execution of the instructions by the processor to train the artificial intelligence model, cause the processor to perform further actions, the further actions comprising:
receiving a type of each respective training legal document of the plurality of training legal documents;
receiving a document position for each respective training legal document where one or more keywords are located in the respective training legal document; and
analyzing the plurality of training legal documents, the type of each respective training legal document, and the document position of the one or more keywords located in each respective training legal document using one or more artificial intelligence training mechanisms to train the artificial intelligence model.

14. The non-transitory computer-readable storage medium of claim 12, wherein execution of the instructions by the processor to train the artificial intelligence model, cause the processor to perform further actions, the further actions comprising:
receiving a type of each respective training legal document of the plurality of training legal documents;
receiving a document position for each respective training legal document where one or more keywords are located in the respective training legal document;
generating a master list that includes the type of each respective training legal document and the document position of the one or more keywords located in each respective training legal document; and
analyzing the master list using one or more artificial intelligence training mechanisms to train the artificial intelligence model.

15. The non-transitory computer-readable storage medium of claim 9, wherein execution of the instructions by the processor to present the plurality of extracted legal documents and the generated events to the user, cause the processor to perform further actions, the further actions comprising:
selecting a legal document from the plurality of extracted legal documents;
presenting the name of the selected legal document to the user;
presenting the event for the selected legal document to the user; and
presenting a preview of one or more pages of the selected legal document to the user.

16. The non-transitory computer-readable storage medium of claim 15, wherein execution of the instructions by the processor, cause the processor to perform further actions, the further actions comprising:
receiving a modification to one or more of the name of the selected legal document, the event for the selected legal document, or one or more pages of the selected legal document; and
updating the portfolio for the legal case based on the received modification.

17. A computing device, comprising:
a non-transitory memory that stores computer instructions; and
a processor that executes the computer instructions to:
obtain a file associated with a portfolio for a legal matter, wherein the file includes a plurality of legal documents;
extract the plurality of legal documents from the file using an artificial intelligence model;
select a name for each respective extracted legal document of the plurality of extracted legal documents based on a match between keywords in the respective extracted legal document and a list of known legal document names;
generate an event for each respective extracted legal document based on the name of the respective extracted legal document and data within the respective legal document;
update the portfolio for the legal matter with the plurality of extracted legal documents and the generated events; and
present the plurality of extracted legal documents and the generated events to a user.

18. The computing device of claim 17, wherein the processor further executes the computer instructions to:
receive a type of each respective training legal document of a plurality of training legal documents;
receive a document position for each respective training legal document where one or more keywords are located in the respective training legal document; and
train the artificial intelligence model based on an analysis of the plurality of training legal documents, the type of each respective training legal document, and the document position of the one or more keywords located in each respective training legal document using one or more artificial intelligence training mechanisms.

19. The computing device of claim 17, wherein the processor further executes the computer instructions to:
receive a type of each respective training legal document of a plurality of training legal documents;
receive a document position for each respective training legal document where one or more keywords are located in the respective training legal document;
generate a master list that includes the type of each respective training legal document and the document position of the one or more keywords located in each respective training legal document; and
train the artificial intelligence model based on an analysis of the master list using one or more artificial intelligence training mechanisms.

20. The computing device of claim 17, wherein the processor presents the plurality of extracted legal documents and the generated events to the user by further executing the computer instructions to:
select a legal document from the plurality of extracted legal documents;
present the name of the selected legal document to the user;
present the event for the selected legal document to the user;
present a preview of one or more pages of the selected legal document to the user.
receive a modification to one or more of the name of the selected legal document, the event for the selected legal document, or one or more pages of the selected legal document; and
update the portfolio for the legal matter based on the received modification.
